(19) United States
(12) Patent Application Publication
(10) Pub. No.: US 2023/0316214 A1
(43) Pub. Date: Oct. 5, 2023

(54) METHODS AND SYSTEMS FOR PRIORITIZATION OF SELECTED OVERSEAS IMPORTS AND IMPROVING VISIBILITY AND PREDICTION OF IMPORT STATUS

(71) Applicant: Target Brands, Inc., Minneapolis, MN (US)

(72) Inventors: Logan Clemment, St. Louis Park, MN (US); Hunter Christian Henke, Minneapolis, MN (US); John Jeatran, Portland, OR (US); Carlos Llanes, Edina, MN (US); Rachel Ann Schmidt, Bloomington, MN (US); Krista Swedenburg, Minneapolis, MN (US); Jacob Volkmann, Bloomington, MN (US)

(21) Appl. No.: 18/194,380

(22) Filed: Mar. 31, 2023

Related U.S. Application Data
(60) Provisional application No. 63/326,662, filed on Apr. 1, 2022.

(51) Int. Cl. G06Q 10/0831; G06Q 10/1093; G06Q 10/0834; G06Q 10/0635

(52) U.S. Cl. CPC G06Q 10/0831; G06Q 10/1097; G06Q 10/0834; G06Q 10/0635

(57) ABSTRACT

Systems and methods for providing prioritization of specific items at specific times in a manner that is provided to an overseas transport logistics software program, and that provide for visibility and prediction of status and risks. In examples, a set of enterprise priorities may be input from a variety of enterprise planning teams into a prioritization software tool. The prioritization software tool may then, based on relative priorities of items currently scheduled for overseas transport, generate a prioritization of items included in pending purchase orders. The prioritization is made accessible to an overseas transport logistics software program. The prioritization may assign individual items to a set of tiers, with each tier having a different handling and overseas shipment prioritization. Shipment information is then received and consolidated, and a dynamic lead time is calculated. The dynamic lead time is utilized to automatically calculate a dynamic risk factor.

### BACKGROUND

Retail enterprises often offer a wide variety of items for sale to customers. Many of the items offered for sale are acquired from overseas vendors. Items procured from such overseas vendors undergo various stages of transportation before arriving at their ultimate location. For example, items will typically undergo inland transportation from the vendors to ports of origin. Then, the items are consolidated and loaded into shipping containers, such as ocean equipment containers, for shipping from the ports of origin, or export gateways, to import gateways. Finally, the items are delivered from the gateways to their ultimate destination.

In the context of a large-scale retail enterprise, the enterprise will often issue a large number of purchase orders to overseas vendors. The enterprise may also coordinate logistics for shipping items from overseas vendors to a domestic port, i.e., an import gateway. The enterprise may also coordinate logistics of consolidating items within a shipping container and writing those items to an appropriate warehouse within the enterprise supply chain, ultimately for delivery to retail locations and/or customers.

In this context, an overseas transport logistics software program will typically receive purchase orders, in the form of electronic data interchange (EDI) transactions and will be used to arrange for such overseas transport. However, purchase orders typically only provide an identification of the items to be shipped, and do not adequately convey specific information about the manner in which overseas transport should be managed. Accordingly, improvements in management of overseas shipping for a retail enterprise are desirable.

When the items of the purchase order are shipped, the enterprise may desire to accurately track their shipment progress and may wish to additionally predict when the items will arrive at their destination. Various enterprise actions, such as product marketing, store planogram layouts, inventory planning, warehouse operations, and downstream transportation mode planning, may be affected by the time an item arrives or is projected to arrive at a destination or other node within the supply chain (for example, a warehouse). An inaccurate indication of item arrival time may result in inefficient supply chain operations and unsatisfactory customer experience. Accordingly, improvements in purchase order item tracking and status prediction are desirable.

### SUMMARY

In general, the present disclosure is directed to systems and methods for providing prioritization of specific items at specific times in a manner that is provided to an overseas transport logistics software program, and subsequently monitoring a status and predicted status of shipped items. In examples, a set of enterprise priorities may be input from a variety of enterprise planning teams into a prioritization software tool. The prioritization software tool may then, based on relative priorities of items currently scheduled for overseas transport, generate a prioritization of items included in pending purchase orders. The prioritization is uploaded to a central location, which is accessible by the overseas transport logistics software program, as well as planning personnel. The prioritization may assign individual items to a set of tiers, with each tier having a different handling and overseas shipment prioritization. Dynamic shipment data may be received and consolidated from different sources, including vendors, carriers, warehouses, and other sources. The data may be parsed by purchase order number. A dynamic lead time and projected arrival date may be calculated and utilized to calculate a dynamic risk factor. An interactive user interface may be generated which displays dynamic data to an enterprise user.

Accordingly, the present application describes a method of managing prioritization of overseas imports includes: receiving a shipping priority from one or more planning systems within an enterprise, the shipping priority being associated with one or more items to be imported via overseas carriers; applying a plurality of business rules to a set of pending purchase orders issued to overseas vendors to determine an overall prioritization of the one or more items as included within the set of pending purchase orders; generating a set of prioritized shipment tiers for the items included within the set of pending purchase orders based on the plurality of business rules; automatically transmitting prioritized shipment information to an overseas transportation management system, the overseas transportation management system being configured to schedule overseas carriers for shipment of the items to the enterprise; and scheduling the overseas carriers for transport of the one or more items within the set of pending purchase orders in accordance with the prioritized shipment information.

In examples, the method further includes receiving, from one or more electronic data interchange transaction tables, dynamic shipment status data associated with the one or more items, wherein at least a portion of the dynamic shipment status data is associated with the overseas carriers; consolidating the dynamic shipment status data, wherein consolidating the shipment status data includes: reconciling the dynamic shipment status data from the one or more electronic data interchange transaction tables; enriching the dynamic shipment status data with data received at least from: an enterprise vendor shipment coordination tool, one or more enterprise routing systems, an enterprise operations management system, and an enterprise inventory system; and parsing the consolidated shipment status data per purchase order; based on the consolidated shipment status data, automatically calculating a dynamic lead time and a dynamic projected arrival date, wherein the dynamic projected arrival date is based at least in part on the dynamic lead time; automatically calculating a dynamic risk factor, the dynamic risk factor being based on the dynamic projected arrival date and indicating a likelihood that the one or more items will not reach the enterprise by a predetermined goal date; and generating a dynamic user interface, the user interface displaying at least the dynamic risk factor.

The present application describes a system for predicting a dynamic risk factor for a shipment of items, the system including: a software tool executable on an enterprise computing system, the software tool comprising computer-executable instructions which, when executed, cause the enterprise computing system to: receive, from one or more electronic data interchange transaction tables, dynamic shipment status data associated with the shipment of items, the shipment of items being included within a set of purchase orders, wherein at least a portion of the dynamic shipment status data is associated with one or more overseas carriers; consolidate the dynamic shipment status data, wherein consolidating the shipment status data includes: reconcile the dynamic shipment status data from the one or more electronic data interchange transaction tables; enrich the dynamic shipment status data with data received at least from: an enterprise vendor shipment coordination tool, one or more enterprise routing systems, an enterprise operations management system, and an enterprise inventory system; and parse the consolidated shipment status data per purchase order; based on the consolidated shipment status data, automatically calculate a dynamic lead time and a dynamic projected arrival date, wherein the dynamic projected arrival date is based at least in part on the dynamic lead time; automatically calculate a dynamic risk factor, the dynamic risk factor being based on the dynamic projected arrival date and indicating a likelihood that the shipment of items will not reach the enterprise by a predetermined goal date; and generate a dynamic user interface, the user interface displaying at least the dynamic risk factor.

In examples, the system further includes instructions causing the enterprise computing system to: receive a shipping priority from one or more planning systems within an enterprise, the shipping priority being associated with the shipment of items, wherein the shipment of items is to be imported via overseas carriers; apply a plurality of business rules to the set of pending purchase orders issued to overseas vendors to determine an overall prioritization of the shipment of items as included within the set of pending purchase orders; generate a set of prioritized shipment tiers for the shipment of items included within the set of pending purchase orders based on the plurality of business rules; automatically transmit prioritized shipment information to an overseas transportation management system communicatively connected to the enterprise computing system, the overseas transportation management system being configured to schedule one or more overseas carriers for shipment of the items to the enterprise; and schedule the one or more overseas carriers for transport of the shipment of items within the set of pending purchase orders in accordance with the prioritized shipment information.

The present application describes a computing system including one or more computing devices, the system comprising instructions to execute a first application and a second application, wherein the first application when executed causes the one or more computing devices to: receive a shipping priority from one or more planning systems within an enterprise, the shipping priority being associated with one or more items to be imported via overseas carriers; apply a plurality of business rules to a set of pending purchase orders issued to overseas vendors to determine an overall prioritization of the one or more items as included within a set of pending purchase orders; generate a set of prioritized shipment tiers for the items included within the set of pending purchase orders based on the plurality of business rules; automatically transmit prioritized shipment information to an overseas transportation management system, the overseas transportation management system being configured to schedule overseas carriers for shipment of the items to the enterprise; and schedule the overseas carriers for transport of the one or more items within the set of pending purchase orders in accordance with the prioritized shipment information. The second application when executed causes the one or more computing devices to: receive, from one or more electronic data interchange transaction tables, dynamic shipment status data associated with the one or more items, wherein at least a portion of the dynamic shipment status data is associated with the overseas carriers; consolidate the dynamic shipment status data, wherein consolidating the shipment status data includes: reconcile the dynamic shipment status data from the one or more electronic data interchange transaction tables; enrich the dynamic shipment status data with data received at least from: an enterprise vendor shipment coordination tool, one or more enterprise routing systems, an enterprise operations management system, and an enterprise inventory system; and parse the consolidated shipment status data per purchase order; based on the consolidated shipment status data, automatically calculate a dynamic lead time and a dynamic projected arrival date, wherein the dynamic projected arrival date is based at least in part on the dynamic lead time; automatically calculate a dynamic risk factor, the dynamic risk factor being based on the dynamic projected arrival date and indicating a likelihood that the one or more items will not reach the enterprise by a predetermined goal date; and generate a dynamic user interface, the user interface displaying at least the dynamic risk factor.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Non-limiting and non-exhaustive examples are described with reference to the following Figures.

FIG. 1 illustrates an example supply chain in which aspects of the present disclosure may be implemented.

FIG. 2 illustrates an example system in which a software tool may prioritize selected overseas shipments.

FIG. 3 illustrates an example system in which a software tool may predict and provide visibility of import status.

FIG. 4 illustrates an example method for managing prioritization of overseas imports.

FIG. 5 illustrates an example method for predicting a dynamic risk factor for a shipment of items and generating an associated dynamic user interface.

FIG. 6 illustrates an example message flow diagram showing integration of overseas shipment prioritization and predicting import status, in accordance with example embodiments.

FIG. 7A illustrates an example message flow diagram showing integration of overseas shipment prioritization and predicting import status, in which a high risk is predicted for a prioritized shipment, in accordance with example embodiments.

FIG. 7B illustrates an example message flow diagram showing integration of overseas shipment prioritization and predicting import status, in which a high risk is predicted for items prior to shipment, in accordance with example embodiments.

FIG. 8A illustrates an example proportion of prioritization among a set of tiers for automated import prioritization by a prioritization software tool, in accordance with example embodiments.

FIG. 8B illustrates an example set of prioritization business rules useable by the prioritization software tool, in accordance with example embodiments.

FIG. 9 illustrates an example user interface including a purchase order tracking tool operable at an overseas transport system depicting an applied prioritization, in accordance with example embodiments.

FIG. 10 illustrates an example user interface including an overall dynamic purchase order visibility dashboard, in accordance with example embodiments.

FIG. 11 illustrates the example user interface of FIG. 10, including customizable user options, in accordance with example embodiments.

FIG. 12A illustrates an example user interface including a user-customized dynamic purchase order visibility dashboard, in accordance with example embodiments.

FIG. 12B illustrates the example user interface of FIG. 12A, including an option for updating a prioritization of a shipment of items, in accordance with example embodiments.

FIG. 13 illustrates an example user interface including calculated risk status on a per-distribution center basis, in accordance with example embodiments.

FIG. 14 illustrates an example user interface including calculated risk status on a per-item basis, in accordance with example embodiments.

FIG. 15 illustrates an example user interface including example logic and calculation data, in accordance with example embodiments.

FIG. 16 illustrates an example user interface including import status on a group and division basis, in accordance with example embodiments.

FIG. 17 illustrates an example user interface including a dynamic purchase order visibility dashboard summary for one or more categories, in accordance with example embodiments.

FIG. 18 illustrates an example user interface including data associated with a subset of a specific event, in accordance with example embodiments.

FIG. 19 illustrates an example computing device which may be used to implement aspects of the present disclosure.

### DETAILED DESCRIPTION

In the following detailed description, references are made to the accompanying drawings that form a part hereof, and in which are shown by way of illustrations specific embodiments or examples. These aspects may be combined, other aspects may be utilized, and structural changes may be made without departing from the present disclosure. Examples may be practiced as methods, systems, or devices. Accordingly, examples may take the form of a hardware implementation, an entirely software implementation, or an implementation combining software and hardware aspects. The following detailed description is therefore not to be taken in a limiting sense, and the scope of the present disclosure is defined by the appended claims and their equivalents.

As briefly described above, embodiments of the present invention are directed to systems and methods for providing prioritization of specific items at specific times in a manner that is provided to an overseas transport logistics software program. In examples, a set of enterprise priorities may be input from a variety of enterprise planning teams into a prioritization software tool. The prioritization software tool may then, based on relative priorities of items currently scheduled for overseas transport, generate a prioritization of items included in pending purchase orders. The prioritization is uploaded to a central location, which is accessible by the overseas transport logistics software program, as well as planning personnel. The prioritization may assign individual items to a set of tiers, with each tier having a different handling and overseas shipment prioritization.

In examples, the prioritization software tool provides a number of advantages and efficiencies in execution of an enterprise supply chain. For example, the prioritization software tool may be used to individually prioritize items, rather than prioritizing entire purchase orders, which allows overseas transport logistics software to separately manage overseas transit of different items from the same vendor, even when presented on the same purchase order. Additionally, because in typical cases enterprise planning personnel may be organized on a per department or per product basis, it is often difficult for even such enterprise planners to objectively prioritize certain items for overseas shipment. By applying a set of objective rules to currently pending purchase orders, and subsequently assigning prioritization tiers to those items/orders, downstream systems, such as an overseas transport logistics software program, may better organize items into shipping containers having different abilities to be expedited, thereby improving efficiency of the overall supply chain, improving efficiency of scheduling by the overseas transport logistics software program, and avoiding supply chain interruptions that might otherwise occur based on mis-prioritization. Additionally, different enterprise planning personnel may apply their own perspective as to prioritization, and the prioritization software tool may integrate those inputs into an overall enterprise prioritization for overseas shipments.

Once the items of a purchase order are shipped, their status may be tracked. Dynamic shipment data may be received and consolidated from different sources, including vendors, carriers, warehouses, and other sources. The data may be parsed by purchase order number to facilitate consolidation, to ensure complete and accurate data, and to allow for filtration and grouping of the data so that calculations may be performed on the data and so that complete and accurate data may be presented to an enterprise user. A dynamic lead time and projected arrival date may be calculated and utilized at least in part to calculate a dynamic risk factor. An interactive user interface may be generated which displays dynamic data to an enterprise user.

The user interface provides information such as dynamic, up-to-date status information, dynamic predicted future status, and dynamic predicted risk (for example, the risk that an item will or will not arrive to a destination at a goal arrival date). The user interface also provides the user with the ability to sort and filter data to narrow in on data specific to important shipments, items, or locations (for example, items of a purchase order which have been prioritized as mentioned above). The enterprise user may then take steps to mitigate any predicted issues to the benefit of the enterprise.

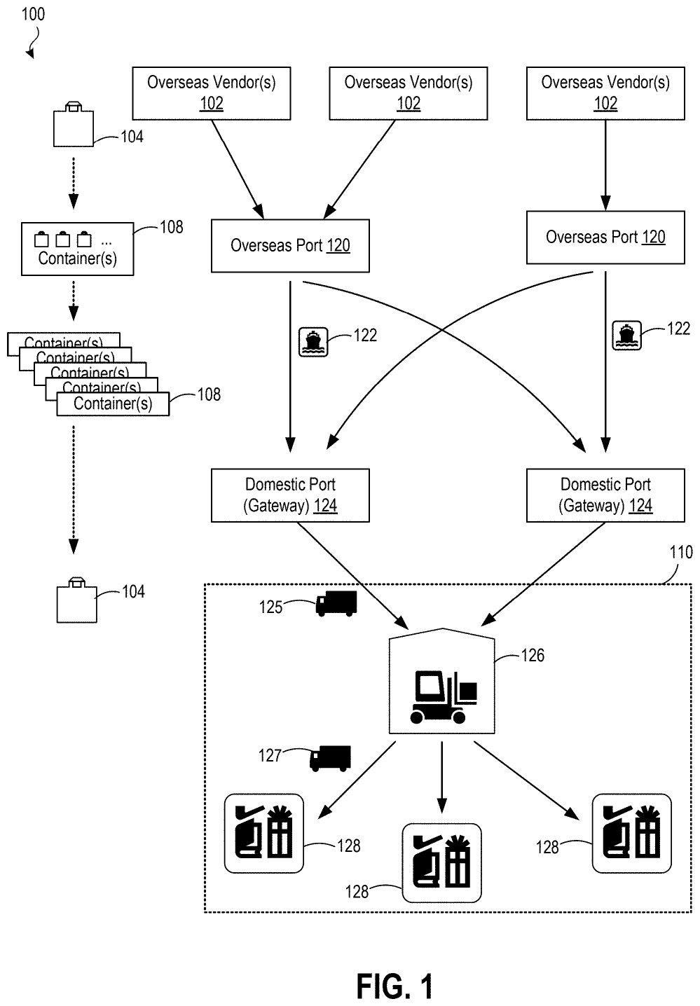

These and other examples will be explained in more detail below with respect to FIG. 1-FIG. 19.

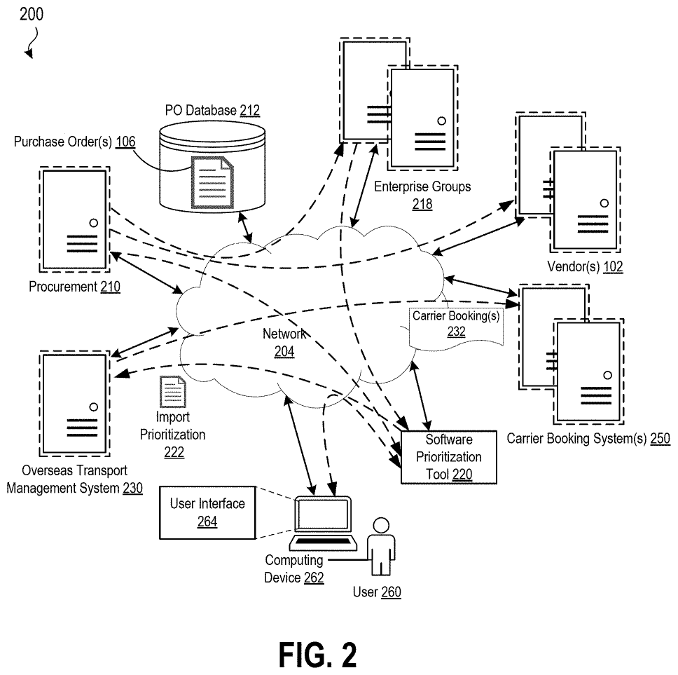

Referring now to FIG. 1, an example enterprise supply chain 100 is shown in which aspects of the present disclosure may be implemented. In the example shown, the enterprise supply chain 100 includes a plurality of overseas vendors 102, which provide items 104 in response to purchase orders 106 (seen in FIG. 2), which may have been received from a retail enterprise 110 (for example, a retail enterprise). In some examples, vendors 102 may be product suppliers, distributors, manufacturers, growers, packagers, or processors. In some examples, vendors 102 may reside overseas from the enterprise. In the example shown, the retail enterprise 110 will schedule transport of items from the overseas vendors 102. This includes organizing items 104 into shipping containers 108 and transit from an overseas port 120 via a selected carrier 122 to a domestic port 124, or gateway, at which items 150 may be de-consolidated from the shipping container and provided to the retailer, for example at a warehouse 126 of the retailer for distribution downstream within a retail supply chain.

In the example shown, the retail enterprise 110 provides purchase orders 106 to the various overseas vendors 102 that include a plurality of items 104. Not all of these items require prioritize shipment via an overseas carrier 122. Furthermore, different carriers 122 (for example a cargo ship, barge, freighter, or air freight) may be able to prioritize shipments to the domestic port 124 (for example, a sea or river port for accepting ships or an airport for accepting air freight) at different rates. Furthermore, a domestic port 124 may have a particular capacity, and therefore a carrier 122 that ships goods through a particular domestic port 124 may have and overall import capacity restriction. Different overseas carriers 122 may ship items through different domestic ports 124, and therefore at different times may be subject to different import capacity restrictions.

In some examples, the items may be transported from the domestic ports 124 and may be processed by a deconsolidator facility to break the shipments of items into smaller shipments or other groupings of products. In some examples, the items may not be processed by a deconsolidator facility. Items from domestic ports 124 and/or a deconsolidator facility may be transported by a carrier 125. In some examples, carrier 125 may include a cargo ship, barge, or other means of water transport; rail transport; truck (for example, light trucks, heavy trucks, tanker trucks, semi trucks, cargo vans, or other road vehicles); and/or air freight.

In the example shown, items may be transported to warehouse 126. In some examples, items may pass through more than one warehouse 126. In some examples, warehouse 126 may represent a storage warehouse, mixing center, sortation center, distribution center, pack and ship warehouse, or other appropriate facility type.

In some examples, items are transported from warehouse 126 to a store or other destination 128. In some examples, destination 128 may be representative of a retail store or other point of sale, a customer location, or a warehouse (which may supply retail stores, online orders, or others as appropriate).

In the example shown, the retail enterprise 110 may use an overseas transport logistics software program (discussed at least in FIG. 2, below) to select specific carriers, ports, and prioritizations for individualized items. That is, the retail enterprise 110 may, based on a prioritization provided by a prioritization software tool, discussed herein, select specific items for priority in import. Those items may be placed within a shipping container that is designated for priority transit, to ensure that, to the extent a carrier or port has a capacity restriction, that shipping container will be prioritized for import over other shipping containers which may contain lower priority items.

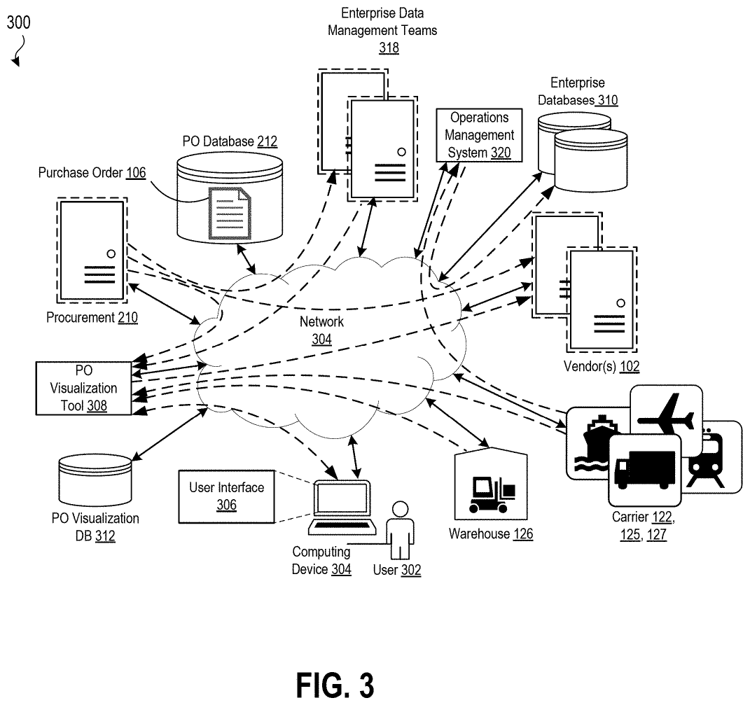

In the example shown, the retail enterprise 110 may use a software platform (as discussed at least in FIG. 3 below) to monitor current status of the items along the supply chain 100, and to predict future status. In some examples, the software platform may associate a risk with the predicted future status. The retail enterprise 110 may make decisions and/or changes based on the predicted status and/or calculated risk.

FIG. 2 illustrates an example system 200 in which a software tool may prioritize selected overseas shipments. In the example shown, a procurement system 210 may issue a purchase order 106 to one or more vendors 102 (for example, overseas or domestic vendors) for items to be acquired by the retail enterprise (for example such as retail enterprise 110) for offer to customers. The purchase order 106 may be stored within a database 212 by the procurement system 210, or otherwise may be maintained within the enterprise. In some examples, the purchase order 106 may define a shipment of items which is to be shipped from a particular vendor 102 to a particular destination 128. A purchase order 106 may include shipment information including one or more of: vendor, vendor location, deconsolidator facility, warehouse facility, facility locations, destination, destination location, items, item description, item attributes and parameters, shipping parameters, shipment receipt date, earliest eligible pickup date, and other information.

A prioritization software tool 220 may receive user prioritization from a variety of planning (enterprise) groups 218 within the enterprise. For example, as noted above, different planning groups 218 may apply different prioritizations to subsets of items based on priorities, with an enterprise-wide planning group applying general enterprise priorities, and subgroups focused on particular types of items may apply separate prioritizations among those items. Additionally, those planning groups 218 need not know specific shipping constraints or conditions, relying instead on a downstream overseas transportation management system/group 230.

In the example shown, the prioritization software tool 220 may apply a set of business rules to generate an import prioritization 222, which is provided to overseas transport management system 230. The overseas transport management system 230 may plan for transport of the items obtained from the vendors 102 (for example, by arranging logistics for transport of those items via overseas carriers 122). In the example shown, the overseas transport management system 230 issues carrier booking requests 232 to carrier booking systems 250. The carrier booking requests 232 may identify a carrier, a prioritization to that carrier, and optionally a particular shipment or prioritization of shipment for particular items associated with one or more particular purchase orders 106.

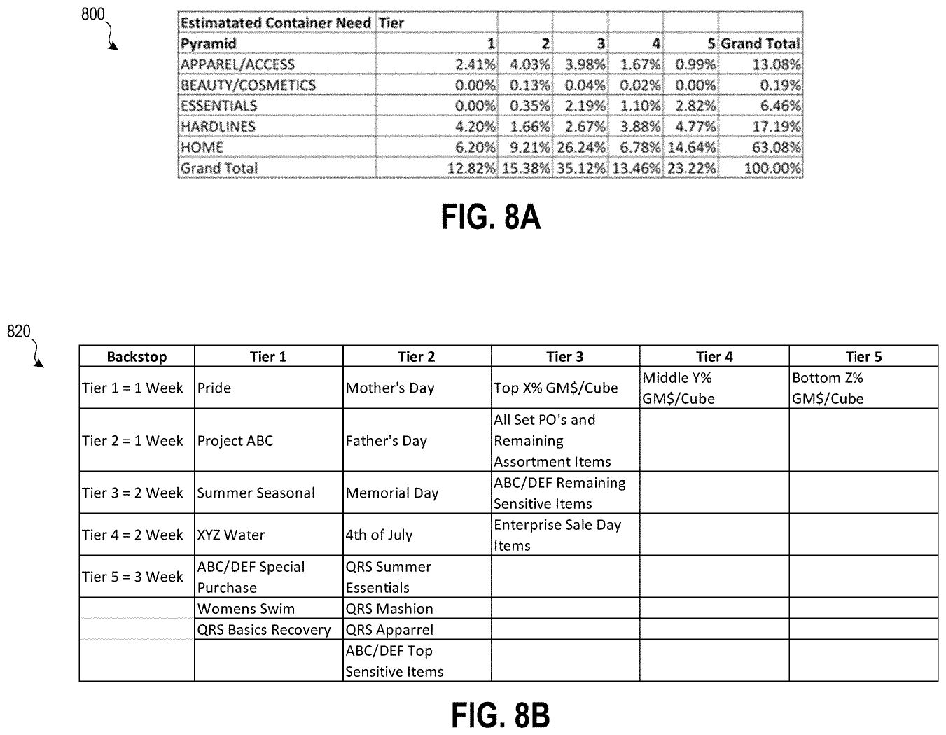

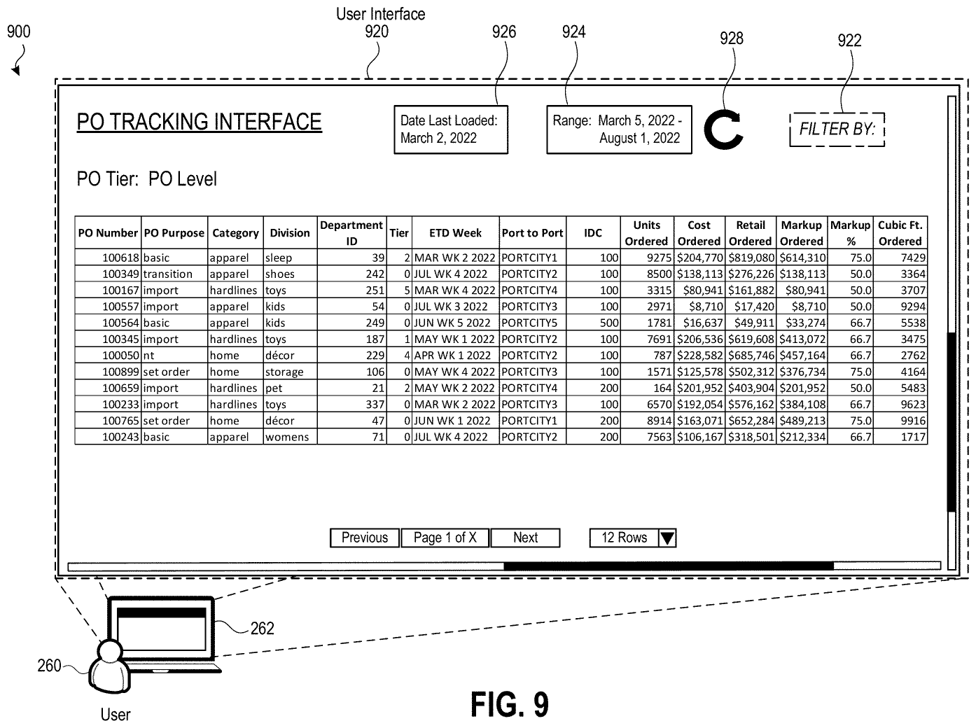

In some examples, the import prioritization 222 generated by software prioritization tool 220 may be displayed via a computing device 262 on one or more generated user interfaces 264 which is accessible by a user 260. In some examples, user 260 is an enterprise user. In an example, enterprise user 260 is an employee, operator, manager, or other agent of the enterprise. One or more user interfaces 264 may be viewed and interacted with by user 260 via device 262. In some examples, the one or more user interfaces 264 allow the user 260 to access, review, or otherwise interact with one or more of the applications/platforms of system 200. In some examples, user interface 264 may include information relating to the import prioritization 222, for example, information as contained in FIGS. 8A, 8B, and 9 as discussed below.

In some examples, device 262 may be a desktop computer, a laptop computer, a tablet, a cell phone, a smart TV, a smart wearable device, or other appropriate electronic device which is capable of displaying and facilitating interaction with the user interface 264.

In some examples, the components of system 200 may send and/or receive data via network 204. In some examples, as described herein, network 204 may include a computer network, an enterprise intranet, the Internet, a LAN, a Wide Area Network (WAN), wireless transmission mediums, wired transmission mediums, other networks, and combinations thereof. Although network 204 is shown as a single network in FIG. 2, this is shown as an example and the various communications described herein may occur over the same network or a number of different networks.

FIG. 3 illustrates an example system in which a software tool may predict and provide visibility of import status. In the example shown, as described above, a procurement system 210 may issue a purchase order 106 to one or more vendors 102 for items to be acquired by the retail enterprise for offer to customers and which are to be shipped to a particular destination 128. The purchase order 106 may be stored within a database 212 by the procurement system 210, or otherwise may be maintained within the enterprise.

In some examples, a purchase order visualization tool 308 may receive dynamic shipment status data associated with the items of the purchase order 106 from carriers 122, 125, 127, warehouse 126, and/or from enterprises databases 310 (in examples where enterprise databases 310 include information received from carriers 122, 125, 127 and/or warehouse 126, which may be stored as one or more electronic data interchange transaction tables). Purchase order visualization tool 308 may further receive information (dynamic or static) from other enterprise data management systems or teams 318, including an enterprise vendor shipment coordination tool, one or more enterprise routing systems, an enterprise operations management system, and/or an enterprise inventory system. The purchase order visualization tool 308 may calculate a dynamic lead time for the shipment of items, a dynamic projected arrival date for the shipment of items, and a dynamic risk factor for the shipment of items. Calculated dynamic lead times, projections, and/or risk factors may be stored in a purchase order visualization database 312.

As introduced above, enterprise databases 310 may include data received from carriers 122, 125, 127; warehouse 126; various enterprise data management teams/systems 318, or other enterprise sources. Data stored may be in electronic data interchange transaction tables. Information stored in enterprise databases 310 may be received and updated dynamically. This may include receiving information (for example, status of a shipment from a carrier 122, 125, 127) as it occurs and real-time, or on a periodic bases (for example, every certain number of seconds, minutes, hours, days, etc.). Any of enterprise database 310, purchase order database 212 (storing purchase order(s) 106), and/or purchase order visualization database 312 may be separate from or integral with one or more of each other.

Operations management system 320 may receive data from carriers 122, 125, 127 (for example, data relating to one or more shipments of items associated with purchase order 106), and may aggregate and/or consolidate the received data into enterprise databases 310 (in some examples, into one or more electronic data interchange transaction tables).

The purchase order visualization tool may generate one or more dynamic, interactive, user interface(s) 306, to be displayed on computing device 304 to be accessed by user 302. The user interface 306 may include one or more interfaces and pages including information accessed from purchase order visualization database 312, including shipment status and risk factors relating to the shipment of items. Information may be presented at a variety of levels, as described in additional detail below. The information presented on user interface 306, because of its dynamic nature, may enable user 302 to better plan and monitor enterprise supply chain activities to benefit the enterprise.

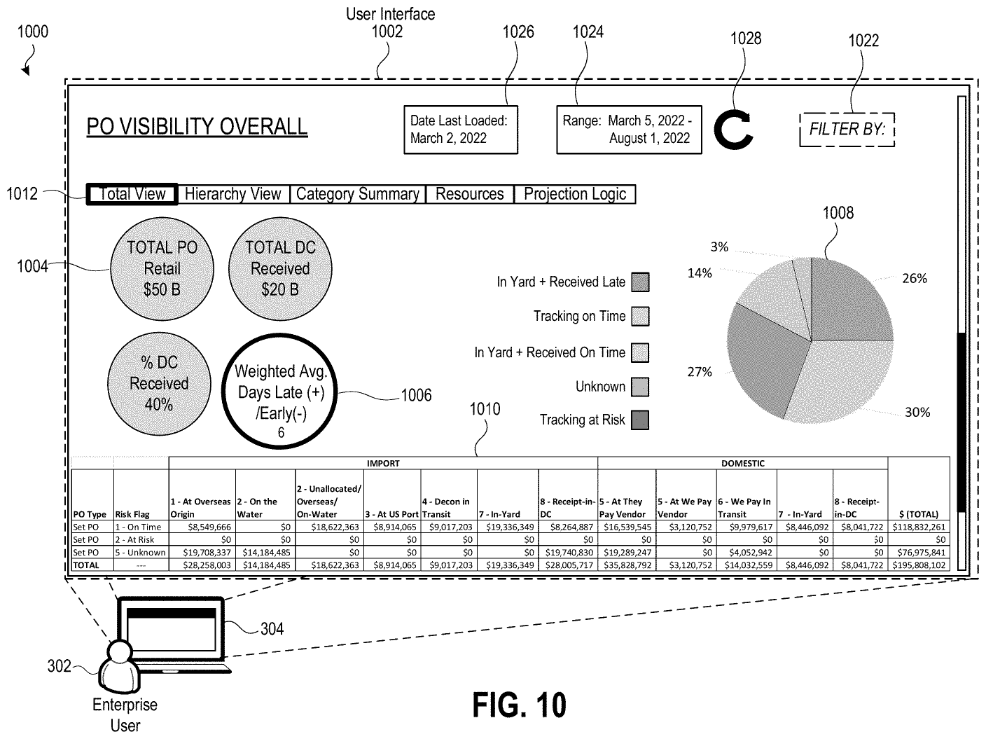

In some examples, user 302 is an enterprise user. In an example, enterprise user 302 is an employee, operator, manager, or other agent of the enterprise. One or more user interfaces 306 may be viewed and interacted with by user 302 via device 304. In some examples, the one or more user interfaces 306 allow the user 302 to access, review, or otherwise interact with one or more of the applications/platforms of system 300. In some examples, user interface 306 may include information relating to the import prioritization 222, for example, information as contained in FIGS. 10-18 discussed below.

In some examples, device 304 may be a desktop computer, a laptop computer, a tablet, a cell phone, a smart TV, a smart wearable device, or other appropriate electronic device which is capable of displaying and facilitating interaction with the user interface 306.

In some examples, the components of system 200 and system 300 may exist within a same larger enterprise system.

In some examples, the components of system 300 may send and/or receive data via network 304. In some examples, as described herein, network 304 may include a computer network, an enterprise intranet, the Internet, a LAN, a Wide Area Network (WAN), wireless transmission mediums, wired transmission mediums, other networks, and combinations thereof. Although network 304 is shown as a single network in FIG. 3, this is shown as an example and the various communications described herein may occur over the same network or a number of different networks. Although network 304 is named as a distinct network from network 204, in some examples, networks 204, 304 represent a singular network or a shared group of different networks.

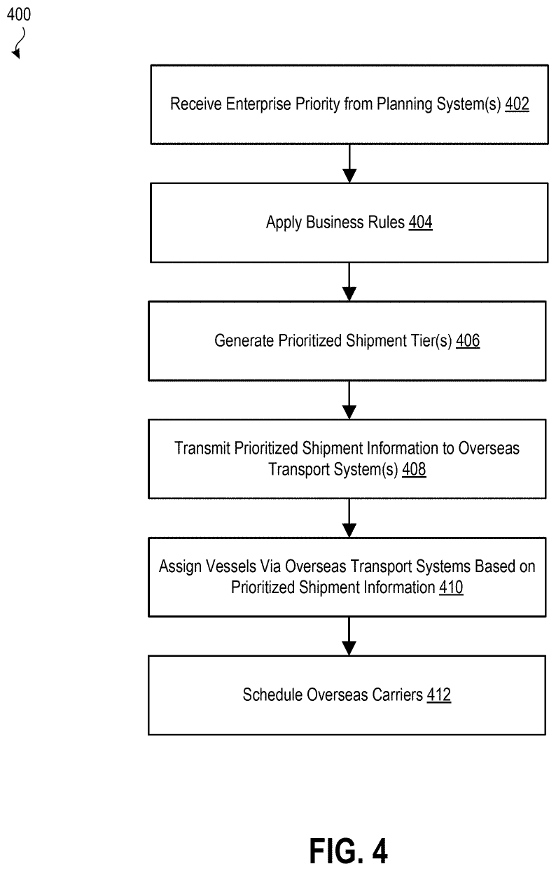

FIG. 4 illustrates an example method 400 for managing prioritization of overseas imports. The method 400 may be performed, for example, by a prioritization software tool (such as software prioritization tool 220) and, in some cases, further by overseas transport management software or systems (such as overseas transport management system 230), as described above in conjunction with FIG. 2.

In the example shown, the method 400 includes receiving enterprise priorities from a planning system (step 402). Enterprise shipping priorities, such as those described in FIGS. 8 and 9, may be received from one or more planning systems within an enterprise (for example, enterprise groups 218). The enterprise shipping priorities may be associated with one or more items to be imported via overseas carriers (for example, carrier(s) 122). Receiving enterprise priorities can include, for example, receiving a relative prioritization from one or more planning entities within a retail enterprise. In some examples, the shipping priority information from the plurality of enterprise planning groups may be reconciled to provide overall enterprise shipping priority information. In example embodiments, the prioritization is received relative to the same item from different enterprise planning groups, and the prioritization software tool may apply relative prioritization based on overall business priorities of the enterprise. In other embodiments, the prioritization is received relative to different items from different planning groups within the retail organization.

In some examples, a high shipping priority may indicate that all items included in the purchase order that contains the items associated with the shipping priority must be treated as having a high shipping priority, as shipment of the entire purchase order may be prioritized and scheduled (described further below) accordingly. In example implementations, the prioritization software tool assigns a prioritization to only some of the items in pending purchase orders. In other implementations, the prioritization software tool assigns a prioritization to all items in pending purchase orders, with the items being assigned to different tiers. A target distribution of items across the tiers may be enforced by the prioritization software tool, thereby limiting the extent to which items are included in a higher prioritization tier.

In example implementations, the prioritization includes a ranking of importance of individualized items. In other implementations, the prioritization includes an identification of one or more items or item types (e.g., brands, items included within a campaign, and the like) that are to be prioritized.

In the example shown, the method 400 includes applying a plurality of business rules to a set of pending purchase orders (for example, purchase order(s) 106) issued to overseas vendors (for example, vendors 102) to determine an overall prioritization of the one or more items as included within the set of pending purchase orders (step 404). In example implementations, the one or more business rules may be applied to any outstanding purchase orders associated with imported items in an upcoming period of time, such as one month, one quarter, etc. The business rules may include, for example, rules associated with specific prioritizations. For example, a user (in some examples, user 260) may enter a prioritization associated with a campaign or promotion (e.g. a spring sale, back to school, and the like), and the business rules may identify related items, and therefore related purchase orders including items that may be associated with that campaign.

In some examples, a department level prioritization may be received from a first planning group, and an overall enterprise prioritization may be received from a second planning group. The department level prioritization may be applied as a subsidiary prioritization to the overall enterprise prioritization.

In some examples, the business rules may define a breakdown of the prioritization of items across tiers for purposes of overseas shipment. For example, one possible business rule may be to prioritize less than 30% of overall import container volume into high priority tiers. Another business rule may be to validate the volume included in a top one or two tiers by the origin with an overseas transport logistics team. An additional or alternative business rule may be to generate a monthly prioritization at a particular time, for example the first week of each month, or using shipping dates that begin in the following month.

In further examples, the business rules may include a definition of tiers that are manually refreshed on a recurring (for example, weekly, monthly, etc.) basis to capture new purchase orders issued during the prior week. In such examples, a placeholder prioritization, such as assigning a particular item and purchase order to a default tier (e.g., “Tier 0”) may be used.

In the example shown, the method 400 includes generating prioritized shipment tiers for the items included within the set of pending purchase orders based on the plurality of business rules (step 406). The prioritized shipping tiers may be defined in a variety of ways. In one example implementation, five different shipping tiers may be defined, with each tier being assigned a different prioritization, with tier 1 having a highest prioritization, and tier 5 having a lowest prioritization. Tier 1 items and purchase orders may be assigned to premier carriers whenever possible, thereby ensuring prioritized handling. Subsequent tiers may be booked with overseas carriers in order of prioritization, and to ensure that delays of shipment of items in higher tiers are avoided. For example, backstop logic may be applied such that items and purchase orders assigned to Tiers 1-2 may be acceptable to dwell in place for up to one week, while items and purchase orders in Tiers 3-4 may be acceptable to dwell in place for up to two weeks. Items and purchase orders in Tier 5 may be acceptable to dwell in place for up to three weeks before prioritization decisions are made. Although the examples herein utilize five numbered Tiers 1-5 and a Tier 0, any number of tiers may be utilized to meet the enterprise planning and tracking needs.

In the example shown, the method 400 further includes automatically transmitting prioritized shipment information to an overseas transportation management system (step 408) (for example, overseas transport management system 230). The overseas transportation management system may be configured to schedule overseas carriers (for example, carrier(s) 122) for shipment of the items to the enterprise. The overseas transportation management system (which may also be referred to as the overseas transport system) may be an overseas transport logistics software program used by the retail enterprise to schedule shipments of items that are included on purchase orders. The prioritized shipment information may include identifications of items and purchase orders, as well as an assigned tier for each item and purchase order, such that the overseas transport system may, either manually or automatically, schedule a carrier and shipment timing.

Subsequently, via the overseas transport system, the method 400 may include assigning vessels based on the prioritized shipment information (step 410) and the overseas vessels (carriers) may be scheduled for transport of the one or more items within the set of pending purchase orders in accordance with the prioritized shipment information (step 412). In some examples, this assignment and scheduling may take the form of a carrier booking 232 as described above. Accordingly, higher priority items may be slotted onto carriers, and into shipments, having a greater likelihood of timely shipment, and a lower likelihood of experiencing delays due to capacity constraints of the carrier, or of the domestic port (gateway) receiving the container.

Referring to FIG. 4 generally, the method 400 may be executed periodically, for example weekly or monthly, to ensure capture and prioritization of any newly generated purchase orders issued by the retail organization. In doing so, a predetermined prioritization may be assigned (for example, by prioritization software tool 220), such as a tier of import priority selected from a set of tiers, for import of particular items. The specific tier assigned to an item may vary over time, and the specific carrier and prioritization may vary over time as the priorities of the enterprise change (for examples, seasons, promotions, etc), as the capacity constraints and volumes available from the carriers and at import ports (gateways) change, and the like. Accordingly, the method 400 and the system that executes the method allow for reconciliation of a variety of priorities and provide a unified, centrally managed priority of shipment on a weekly or other periodic basis to the overseas transport management system, to facilitate improved prioritization of overseas shipments.

The prioritization software tool also may provide a central prioritization mechanism by which individual priorities of stakeholders within the enterprise may be aggregated and reconciled, thereby ensuring an appropriate enterprise-wide prioritization of item imports.

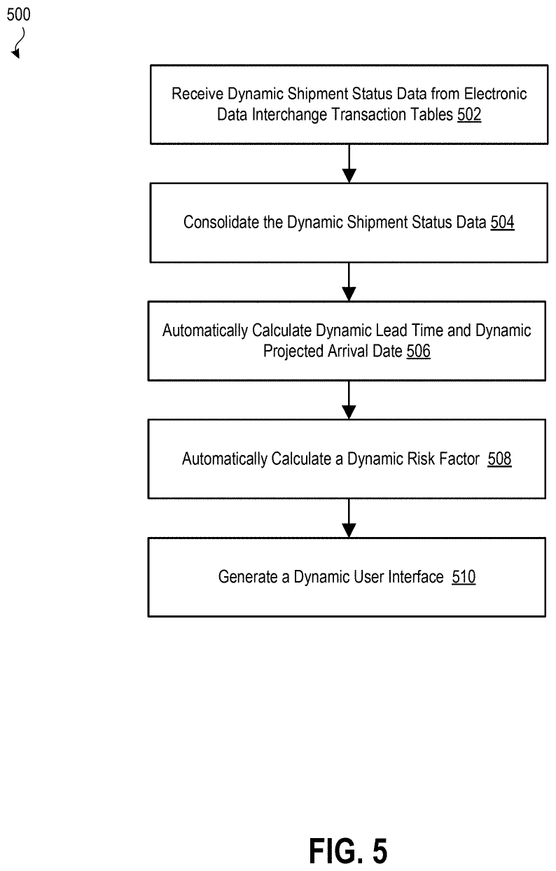

In some examples, an enterprise user may wish to dynamically track one or more shipments (assigned to a carrier) associated with one or more purchase orders or may wish to view dynamic data relating to a predicted arrival time at a destination, and/or a predicted risk that the shipments of items will not arrive on time, so that corrective action may be taken to mitigate risk. This may be especially important for items assigned a high priority, as they may represent a larger portion of sales and/or revenue for the enterprise. Such data may be generated/calculated and presented in some examples via the method 500 outlined in FIG. 5 below.

FIG. 5 illustrates an example method for predicting a dynamic risk factor for a shipment of items and generating an associated dynamic user interface.

In the example shown, the method 500 includes receiving, from one or more electronic data interchange transaction tables (for example, stored in enterprise databases 310), dynamic shipment status data associated with a shipment of items (step 502). In some examples, the shipment of items is included within a set of purchase orders. In some examples, at least a portion of the dynamic shipment status data is associated with one or more overseas carriers.

In some examples, the dynamic shipment status data associated with the shipment of items is received from an operations management system communicatively connected to the enterprise computing system. The operations management system may be configured to receive raw shipment status data from the one or more overseas carriers on a purchase order basis, and to aggregate the raw shipment status data into the one or more electronic data interchange transaction tables.

In the example shown, the method 500 includes consolidating the dynamic shipment status data (step 504). In some examples, consolidating the shipment status data may include reconciling the dynamic shipment status data from the one or more electronic data interchange transaction tables; enriching the dynamic shipment status data (for example, with data received at least from an enterprise vendor shipment coordination tool, one or more enterprise routing systems, an enterprise operations management system, and/or an enterprise inventory system). In some examples, the consolidated shipment status data may be parsed per purchase order. In some examples, shipment status data may be received relating to a particular purchase order that may have originated through communication channels associated with more than one enterprise group or system. In such examples, the data may be consolidated, which may include cleaning up duplicate values, determining accuracy/validity of conflicting values for the same piece of information, filling in missing information from one source with information from another source, or other data aggregation techniques. Consolidation (for example, by purchase order visualization tool 308) may generate new dynamic data tables which may be stored in a database (for example, purchase order visualization database 312).

In the example shown, the method 500 includes automatically calculating (for example, by the purchase order visualization tool 308) a dynamic lead time and a dynamic projected arrival date, based on the consolidated shipment status data (step 506). In some examples, the dynamic projected arrival date is based at least in part on the dynamic lead time. For example, if dynamic shipment status data received from a carrier shows that the carrier vehicle is several days behind schedule, the dynamic lead time may be adjusted to account for the extra several days, and correspondingly, the dynamic projected arrival data may be adjusted to account for the adjusted dynamic lead time.

In some examples, calculating the dynamic lead time includes identifying a trend in the consolidated shipment status data, and wherein the dynamic lead time is based at least in part on the identified trend. For example, a particular carrier may be consistently or increasingly taking longer to deliver shipments of items than an originally predicted lead time. In another example, a particular carrier may be taking increasingly longer lead times to deliver shipments of items over a period of time.

In the example shown, the method 500 includes automatically calculating (for example, by the purchase order visualization tool 308) a dynamic risk factor (step 508). In some examples, the dynamic risk factor is calculated based on the dynamic projected arrival date. In some examples, the dynamic risk factor indicates a likelihood that the shipment of items will not (or will) reach the enterprise (for example, the destination 128) by a predetermined goal delivery date.

In some examples, risk factors may be assigned on a category or “flag” basis. For example, risk factors may be determined to correspond to risk factors such as: risk factor 1 for a predicted on-time delivery, risk factor 2 for a delivery time which is at risk of being late, and risk factor 3 for data for which a risk factor cannot be determined at the time.

In some examples, calculating the dynamic risk factor includes calculating the dynamic risk factor for all items associated with one purchase order of the set of purchase orders. In some examples, calculating the dynamic risk factor includes calculating the dynamic risk factor for one item associated with one purchase order of the set of purchase orders. In some examples calculating the dynamic risk factor includes calculating the dynamic risk factor for a subset of items associated with one purchase order of the set of purchase orders.

In the example shown, the method 500 includes generating a dynamic user interface (step 510) (for example, user interface 306). In some examples, the user interface displays at least the dynamic risk factor. In some examples, the dynamic user interface includes filters, options, selections, or other features that a user (for example, user 302) may interact with in order to view different or additional dynamic data. FIGS. 10-18 below provide further detail regarding characteristics of example dynamic user interfaces.

In some examples, method 500 further includes receiving, from the one or more electronic data interchange transaction tables, second dynamic shipment status data associated with the one or more items. This second dynamic shipment status data may be, for example, a data point relating to a shipment status location of an item along a shipping route that was taken later in time than the first shipment status data. The second dynamic shipment status data may be consolidated as outlined in step 504, including reconciling the second dynamic shipment status data from the one or more electronic data interchange transaction tables; enriching the second dynamic shipment status data (with data received at least from an enterprise vendor shipment coordination tool, one or more enterprise routing systems, an enterprise operations management system, and/or) an enterprise inventory system; and parsing the second consolidated shipment status data per purchase order. In some examples, a second dynamic lead time and a second dynamic projected arrival date are automatically calculated (as outlined in step 506), based on the second consolidated shipment status data, thus reflecting an updated status of the shipment of items. In some examples, the second dynamic projected arrival date is based at least in part on the second dynamic lead time. A second dynamic risk factor may be automatically calculated (as outlined in step 508) which is based on the second dynamic projected arrival date and which indicates a likelihood that the one or more items will not (or will) reach the enterprise by the predetermined goal date.

In some examples, the second dynamic risk factor and/or additional data relating to the shipment of items may be displayed on the generated user interface (for example, user interface 306), to provide updated information to the user (for examples, user 302).

In some example implementations, the shipment of items has an assigned a priority (for example, a set or prioritized shipment tiers assigned via method 400) and was assigned to the one or more overseas carriers based on the assigned priority.

In some examples, method 500 further includes determining that the dynamic risk factor indicates that the one or more items will not reach the enterprise by the predetermined goal date. If such a determination is made, a second set of prioritized shipment tiers may be generated for the one or more items (for example, based on a plurality of business rules as in method 400 and the determination). A second instance of prioritized shipment information may be automatically transmitted to the overseas transportation management system (for example, overseas transportation management system 230), and the overseas carriers (the same carriers or, in some examples, a different assigned carrier) may be scheduled for transport of the one or more items within the set of pending purchase orders in accordance with the second instance of prioritized shipment information.

In some examples, method 500 further includes automatically generating a notification and providing that notification to a user (for example, user 260 or user 302). In some examples, these notifications may be displayed to a user via a user interface (for example, such as user interface 306). In some examples, notifications may be provided to a user via a communication message such as a text message, mobile notification, email, in-software notification, or other form of electronic communication.

In some examples, notifications may be generated in response to a determination that an item, shipment of item, or items associated with a particular purchase order are at risk of not arriving to a destination on time (for example, have been assigned to a high risk tier or are estimated to be a number of days over a threshold number of days late). In some examples, these items or shipments of items may be assigned a high prioritization. In some examples, the items may not have been shipped yet, and vendor delays may be at least part of the reason for the high risk. In some examples, the items may have been shipped, and delays relating to carriers and/or warehouses may be at least part of the reason for the high risk.

In some examples, notifications may include at least a calculated risk factor for the item(s). In some examples, notifications may include at least a predicted lead time for the item(s). In some examples, notifications may include at least a projected arrival date for the item(s).

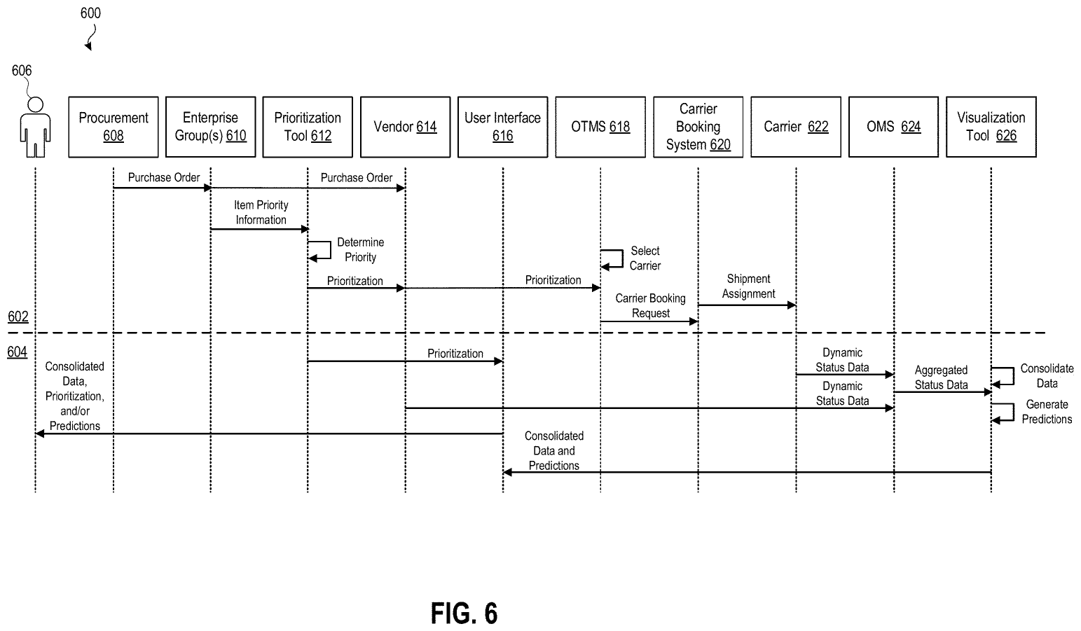

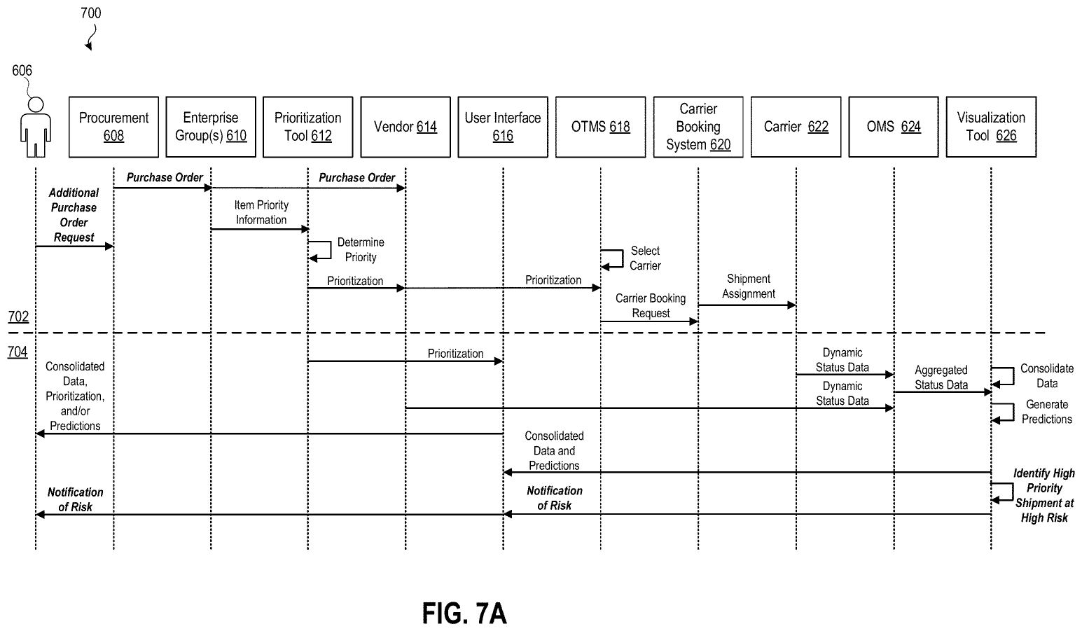

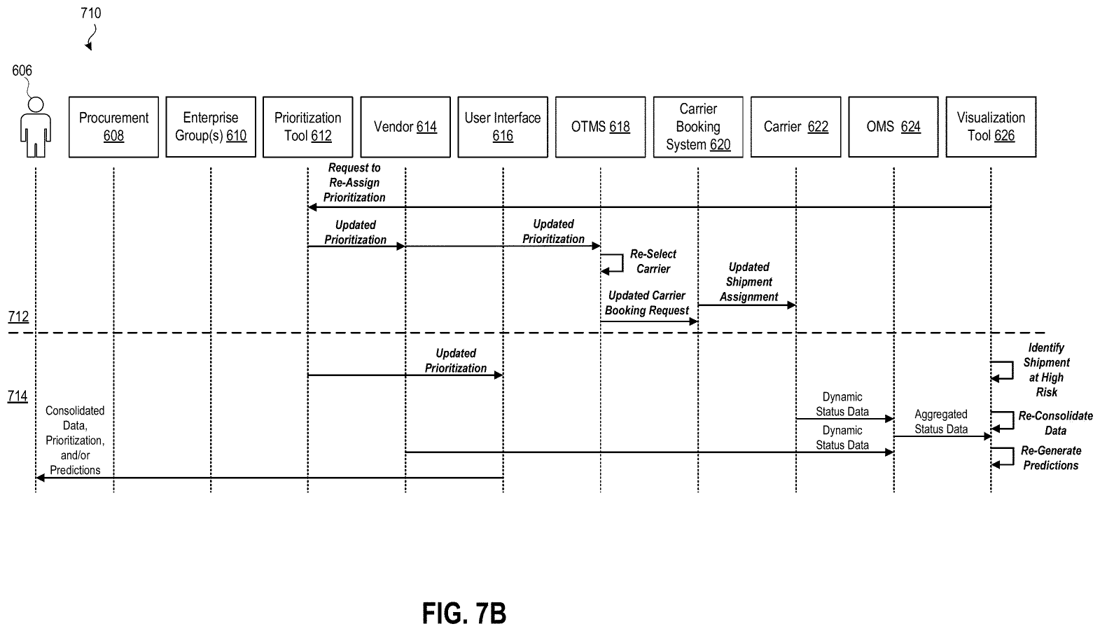

In some examples, receipt of a generated notification may prompt a user to make a change, which may include one or more of: updating/changing prioritization of the item, initiating a different carrier booking or type of carrier service, changing carrier route, changing warehouse and/or deconsolidator requirements, initiating a new purchase order, canceling an existing purchase order, and/or adjusting downstream planning processes (for example, unloading processes, planogram changes, advertising schedules and content, etc). These actions will further impact the systems disclosed herein (for example, the systems of FIGS. 2 and 3), at least because new messages and data will be shared, captured, and transferred between the system. Refer to FIGS. 6, 7A, and 7B for non-exhaustive examples of how such changes in one aspect of a system may affect other systems.

In one possible example, a user interface may indicate, based on the dynamic risk factor, that a particular item shipment or set of item shipments are at risk for late delivery. These shipments may be, for example, items that may have been the subject of purchase orders issued to vendors, but for which, due to vendor delays, the items have not yet been received at an overseas carrier for shipment. In such instances, a user may identify and elect to change a prioritization of those items for shipment, to ensure that the identified items will arrive within a relevant timeframe. In further examples, where re-prioritization may be available (e.g., prior to selection of a prioritization or communication of that prioritization to an overseas carrier), the systems described herein may automatically update a prioritization of the items or shipments to minimize a number of items identified as being at risk of late delivery.

In some examples, method 500 further includes automatically updating/changing a prioritization assigned to an item, shipment of items, subset of items of a purchase order, or all items associated with the purchase order. For example, if a vendor experiences a delay in shipping an item, this may cause the item to be assigned a dynamic risk factor which indicates that the item is high risk for arriving to its destination on time. An increased prioritization may be automatically assigned to the item (for example, from a lower priority to the highest priority). This increase in priority of the item may cause the item to be subject to a new shipment booking, which is selected so as to provide shipping transit having a shorter lead time, so that the item is more likely to arrive to its destination on time (has a lower calculated risk factor), despite the initial delay in shipping. Refer to FIG. 7B for non-exhaustive examples of how such an automatic change in prioritization may affect one or more systems.

In an example, the systems of FIGS. 2 and 3 may be connected and/or may be combined into a single computing system including one or more computing devices. In such an example, the system may execute various software applications, including applications which may perform (or cause devices to perform) the methods outlined in any or all of FIGS. 4 through 6 as discussed herein.

FIG. 6 illustrates an example message flow diagram 600 showing integration of overseas shipment prioritization and predicting import status. The example message flow diagram 600 is illustrated as including a shipment prioritization process 602 and a dynamic risk factor calculation and visualization process 604, among the entities described above in conjunction with FIGS. 1-3. In some examples, the steps of the shipment prioritization process 602 may be described as in the method of FIG. 4. In some examples, the steps of the dynamic risk factor calculation and visualization process 604 may be described as in the method of FIG. 5.

In some examples, a procurement system 608 (for example, analogous to procurement system 210) issues a purchase order (for example, analogous to purchase order 106) for one or more items to be purchased from a vendor 614 (for example, vendor(s) 102) and to be delivered by one or more carriers 622 (for example, carrier 122, 125, 127) to a destination (for example, destination 128). The purchase order may be received by both the vendor 614 and one or more enterprise groups 610 (for example, analogous to enterprise groups 218 and/or enterprise data management teams 318). The enterprise group(s) 610 may provide item priority information (for example, promotions, seasonality, profit margins, and other factors) to prioritization tool 612 (for example, analogous to software prioritization tool 220).

Prioritization tool 612 may determine a priority of one or more items of the purchase order (for example, see the method outlined in FIG. 4). The prioritization may apply to one, several, or all items of the purchase order. The prioritization may be relayed to the vendor 614 and to the overseas transport management system (OTMS) 618 (for example, analogous to overseas transport management system 230). The prioritization may be provided to an interactive user interface 616 (for example, analogous to user interface 306), where it may be visible to a user 606 (for example, analogous to user 302). User interface 306 may indicate at this point a prioritization of the one or more items (and/or of the purchase order itself) and a pre-shipment status.

The OTMS 618 may select a carrier 622 to transport the items from vendor 614 to the destination. The items may be shipped directly from vendor 614 to the destination, or the items may pass through one or more ports, deconsolidators, sortation centers, distribution centers, and/or warehouses. Carrier 622 may represent multiple chosen carriers, where one carrier is needed to pass off the items to another (for example, a ship to a truck, etc.). The OTMS 618 may generate a carrier booking request including information relating to the selected carrier, and the carrier booking request may be provided to the carrier booking system 620 (for example, analogous to carrier booking system(s) 250). Carrier booking systems may then generate a shipment assignment, which may be received by the carrier 622.

Vendor 614 may then prepare the items for shipment, and carrier 622 may pick up the items and carry them to the destination. Vendor 614 may relay dynamic status data, which may be received by an operations management system (OMS) 624 (for example, analogous to operations management system 320). The dynamic status data may include, for example, whether or not a shipment of items is ready for shipment, time when a shipment of items has shipped, location of shipment, and other data. As the shipment of items is moved along its route to its destination, carrier 622 may relay dynamic status data, which may be received by OMS 624. The dynamic status data may include, for example, time that a shipment of items was picked up, a location of a vehicle or other transportation mode carrying the shipment of items, timestamps at locations, times picked up or dropped off at warehouses/deconsolidators etc., and other data.

Received dynamic status data may be aggregated (for example, in one or more electronic data interchange transaction tables) and received by a visualization tool 626 (for example, analogous to purchase order visualization tool 308). The aggregated data may be consolidated (for example, as described in the method of FIG. 5). Predictions may be generated based at least in part on the consolidated data, and may include a dynamic lead time, a dynamic projected arrival date, and a dynamic risk factor. These predictions may be displayed on user interface 616, which may be viewed and interacted with by user 606.

FIG. 7A illustrates an example message flow diagram 700 showing integration of overseas shipment prioritization and predicting import status, in which a high risk is predicted for a prioritized shipment. The example message flow diagram 700 is illustrated as including a shipment prioritization process 702 and a dynamic risk factor calculation and visualization process 704, among the entities described above in conjunction with FIGS. 1-3. In this example, the shipment prioritization process 702 and dynamic risk factor calculation and visualization process 704 are similar to the analogous processes 602, 604 of FIG. 6, but in the particular example shown, a shipment of items has been identified as being at a high risk of not reaching its destination on time (or within a predetermined time window), after the shipment of items has been shipped (has been picked up by carrier 622).

In some examples, after an item has been shipped via carrier 622, a user 606 may monitor the status of the shipment of items and predicted dynamic lead time, arrival date, and risk factors associated with the shipment of items via the user interface 616. The visualization tool 626 may predict that a shipment of items (which may include one or more items which was assigned a high prioritization by prioritization tool 612) is at a high risk of not reaching its destination on time (or within a predetermined time window). Visualization tool 626 may automatically initiate a notification of the high risk associated with the items, which may be received at a user interface 616. User interface 616 may display the notification to the user 606. In some examples, the notification is provided to user 606 by another electronic means (for example, an email, push notification, text message, or other electronic message type).

To mitigate negative cost effects relating to the shipment of items arriving late, the user 606 may initiate a mitigation action. In the particular example shown, the mitigation action may include generating an additional purchase order request, which is received by procurement system 608. Procurement system 608 may generate a new purchase order, for example, a purchase order for replacement items for those on the (now delayed and at-risk) first shipment). This new purchase order may be received by enterprise group(s) 610 and vendor 614. Item priority information may be received at the prioritization tool 612 (from the enterprise group(s) 610, and a priority may be determined for the item(s) of the new purchase order. In some examples, this new prioritization is a higher (more important) prioritization than was assigned to the original items of the original purchase order.

In steps similar to those outlined above with regards to FIG. 6, the prioritization may be passed along to the vendor 614, OTMS 618, and user interface 616. Ultimately, a new shipment assignment is generated so that the shipment of this second set of items is at a lower risk of not arriving to its destination on time. Also as outlined above in FIG. 6, dynamic status data for the new shipment of items may be aggregated and consolidated, and then utilized to calculate predictions (dynamic lead time, dynamic projected arrival date, and dynamic risk factors). The dynamic status data and the calculated predictions associated with the new shipment of items may be reflected on the user interface 616.

FIG. 7B illustrates an example message flow diagram 710 showing integration of overseas shipment prioritization and predicting import status, in which a high risk is predicted for items prior to shipment. The example message flow diagram 710 is illustrated as including a shipment prioritization process 712 and a dynamic risk factor calculation and visualization process 714, among the entities described above in conjunction with FIGS. 1-3. In this example, the shipment prioritization process 712 and dynamic risk factor calculation and visualization process 714 are similar to the analogous processes 602, 604 of FIG. 6, but in the particular example shown, a shipment of items has been identified as being at a high risk of not reaching its destination on time (or within a predetermined time window), before the shipment of items has been shipped (has not yet been picked up by carrier 622).

In some examples, one or more items of a purchase order may have been assigned a prioritization and the vendor 614 has received the prioritization and the purchase order, but the item(s) may not have been picked up by carrier 622 (for example, because of a delay by vendor 614 having the items ready for shipment or a delay by carrier 622 in picking up the shipment). Dynamic status data which reflects this status of the item(s) may be received from the vendor 614 and/or the carrier 622 at the OMS 624. As described above with regards to FIG. 6, this status data may be aggregated and consolidated (at visualization tool 626). Visualization tool 626 may further calculate predictions (dynamic lead time, dynamic projected arrival date, and dynamic risk factors), which may be reflected on the user interface 616, along with dynamic status data.

Visualization tool 626 may, in calculating dynamic risk factors, identify that the items are at a high risk of not reaching its destination on time (or within a predetermined time window). In some examples, visualization tool 626 may automatically generate a request to re-assign the items to a higher prioritization tier. In other examples, visualization tool 626 may cause an interactive option to appear on user interface 616 whereby a user 606 may initiate a request to re-assign the items to a different prioritization tier. A request to re-assign prioritization may be received by prioritization tool 612, which may assign the items (and potentially the purchase order including those items) to a higher prioritization tier.

In steps similar to those outlined above with regards to FIG. 6, the updated prioritization may be provided to the vendor 614 (whereby the vendor 614 may expedite processing of the items), the OTMS 618 (whereby the OTMS 618 may re-select a carrier 622 which is capable of delivering the items according to the new updated prioritization), and the user interface 616 (whereby user 606 can view the updated prioritization of the items). An updated carrier booking request is received by the carrier booking system 620, and an updated shipping assignment is received by the carrier 622 (which may be the same carrier or a different carrier than was originally selected to transport the items).

In steps similar to those outlined above with regards to FIG. 6, dynamic status data associated with the items may be received (for example, by OMS 624), aggregated (by OMS 624), and consolidated (by visualization tool 626), and then utilized to calculate predictions (dynamic lead time, dynamic projected arrival date, and dynamic risk factors). The dynamic status data and the calculated predictions associated with the items may be reflected on the user interface 616, which may indicate that the newly prioritized items are now tracking on time (at a lower risk of not reaching its destination on time (or within a predetermined time window)).

FIG. 8A illustrates a chart 800 showing an example proportion of prioritization among a set of tiers for automated import prioritization by a prioritization software tool in accordance with example embodiments. In the chart 800 as shown, a breakdown of different types of goods, as well as prioritization tier, is shown. In the example provided, it can be seen that less than 15% of total volume of items to be imported are in a highest tier (tier 1), less than 30% of total volume of items to be imported are in a top two tiers (tiers 1-2), and a majority of goods are within the bottom three tiers. This allows for some flexibility of timing of shipment of those de-prioritized items and ensures prioritization of higher value items to the retail enterprise. In the particular example shown, the specific types of goods are broken down into apparel, beauty, essentials, hardlines, and home. This allows for prioritization across these different types of goods and allows planning personnel responsible for each type of goods to prioritize specific goods within any given category or pyramid area. Other types of categories or pyramid areas may be used in other examples.

In some examples, information such as chart 800 may be displayed to a planning personnel user on a generated user interface (for example, to a user 260 via a generated user interface 264).

In some examples, chart 800 may be displayed on a user interface such as user interface 264.

FIG. 8B illustrates an example chart 820 showing a set of prioritization business rules useable by the prioritization software tool 220, in accordance with example embodiments. In the particular example shown, a set of tiers is depicted that includes prioritized categories of items across various types of goods that may be implemented during a spring season. In this example, high priority goods may be assigned to a top-tier (tier 1) and may include store brand items, seasonal items, or items related to a particular promotion (“Pride”, “Project Joy”, “Summer Mini Seasonal”, and the like), or otherwise may include high-priority items having relatively larger profit margin. A second tier (tier 2) may include seasonal goods, such as goods important to be received by a particular holiday (e.g., Mother's Day, Father's Day, Memorial Day, Fourth of July, and like), as well as goods that are time sensitive due to fashion trends. A third tier (tier 3) may include a majority of items, including a top percentage of sellers, time sensitive items, items intended to be sold as part of a special sales event or promotion, etc. A fourth tier may include a set of items identified as being associated with moderate sales (e.g., middle 35%) of overall sales, and a fifth tier (tier 5) may represent a bottom percentage (e.g. bottom 15%) of overall sales of imported goods.

While general campaigns and groups of items are depicted in the example chart 820, it is possible that the prioritization software tool 220 may individually prioritize specific items as falling within a particular tier, or otherwise may override classifications of items to ensure import of specific items on a time sensitive basis.

Accordingly, downstream, the overseas transport management system 230 may schedule specific prioritizing carriers or shipments from among the available carriers based on anticipated capacity and/or other shipping network constraints.

In some examples, chart 820 may be displayed on a user interface such as user interface 264.

FIG. 9 illustrates an example user interface 920 including a purchase order tracking tool operable at an overseas transport system depicting an applied prioritization, in accordance with example embodiments. The purchase order tracking tool user interface 920 (for example, being representative of user interface 264 and displayed on device 262, visible to user 260) displays, in the example shown, pending purchase orders. User 260 may view information displayed on user interface 920 and may interact with user interface 920 utilizing a keyboard, mouse touchpad, touchscreen, remote, voice command, or other interactive methods. In some examples, user interface 920 may be generated so as to allow user 260 to view data at a purchase order level. In some examples, user interface 920 may be generated so as to allow user 260 to view data on a destination, item, category, or other basis. In some examples, user interface 920 may be generated so as to include a feature 922 to allow user 260 to filter data based on a plurality of parameters. In some examples, user interface 920 may be generated so as to include a feature 924 to allow user 260 to select a date range for which to provide data.

In some examples, user interface 920 may be generated so that the data presented is dynamic and may be updated at predetermined time intervals to display the most recent available data. In some examples, user interface 920 may provide an indication 926 of the time and/or date on which the data was last loaded. In some examples, user interface 920 may be generated so as to include a feature 928 to allow user 260 to manually refresh the data to pull in the most recent data.

Each row shown in the user interface 920 may correspond to a different purchase order (for example, purchase order 106). In the example shown, each purchase order may have an associated purchase order number, purchase order purpose, pyramid, division, and/or department. In the example shown, based on the prioritization, each purchase order may also be assigned to a particular tier from among the set of tiers as seen in FIG. 8A. Accordingly, an estimated time of delivery week may be identified, as well as an assigned port that is assigned at the time of carrier booking by the overseas transport system. Additional details regarding the shipment may be provided as well, including a number of units, a cost, a markup, and cubic volume, associated with the order. Other order details may be provided as well.

In some examples, as seen in the purchase order tracking tool interface 920, items having a higher tier assigned to them may be assigned to a different estimated delivery week or port based on the prioritization. Those items that have not yet been prioritized may be assigned to a separate tier, for example to a tier 0, which would indicate that they are awaiting prioritization. Based on a later re-prioritization of those shipments, carrier assignments may be changed or updated. Accordingly, the time of prioritization of specific purchase orders or items may be decoupled from the time at which the overseas transport logistics software program is used to book a particular carrier or shipment for the item. Since shipping network conditions may change between a time the prioritization is received (or times at which prioritizations are received from multiple planning entities within the enterprise) and the time the shipment is booked with a particular carrier, improved efficiency from coordinated enterprise prioritization may be achieved.

FIG. 10 illustrates an example user interface including an overall dynamic purchase order visibility dashboard. In some examples, a display of device 304 may display a user interface 1002 (for example, such as vendor user interface 306). The device 304 may be accessible to an enterprise user 302. User 302 may view information displayed on user interface 1002 and may interact with user interface 1002 utilizing a keyboard, mouse touchpad, touchscreen, remote, voice command, or other interactive methods. In some examples, the user interface 1002 and the data that it displays may be generated as described in the methods described above. The user interface 1002 may be generated, in some examples, by accessing dynamically updated data from one or more databases (for example, purchase order visualization database 312, enterprise databases 310, and/or purchase order database 212).

In some examples, user interface 1002 may present data relating to one or more purchase orders and the shipments of items associated with the purchase orders. In the particular example shown, user interface 1002 includes an overall purchase order visibility page, which displays information relating to all outstanding purchase orders for a specified date range. User interface 1002 includes various summaries 1004 (including a total value of the retail purchase orders, a total value of the items received, and a percentage received), and a weighted average of a number of days late or early for the items received 1006. The summaries 1004 and/or weighted average 1006 may be displayed in different colors based on predetermined performance factors. For example, if the weighted average shows that the items have been over a threshold number of days late, weighted average 1006 may be colored red, but if the items have been over a threshold number of days early, weighted average 1006 may be colored green.

User interface 1002 may also include a graph or chart 1008, depicting status data associated with shipments of items. This status data may include percentages of shipments or items (or values of shipments or items) which are at different stages of the shipment process (for example, in yard (received) and received on time, tracking on time, in yard and received late, tracking at risk (of being received late), and unknown). This status data (as well as data presented elsewhere on user interface 1002) may be actual status data received and consolidated as described above (for example, as outlined in FIG. 5), or it may be predicted data (for example, as outlined in FIG. 5), or a combination of both actual and predicted data.

User interface 1002 may also include a table 1010 depicting additional status data associated with shipments of items. The data may be broken into risk categories, such as on time, at risk, or unknown, in some examples (for example, the risk may be calculated as outlined in FIG. 5). In some examples, the table may include value (for example, dollar amounts) corresponding to different status categories for import and/or domestic shipments of items.

In some examples, information presented to the user 302 via the user interface 1002 may be in the form of text, diagrams, charts, graphs, tables, checklists, radio buttons, lists, or other indicators.

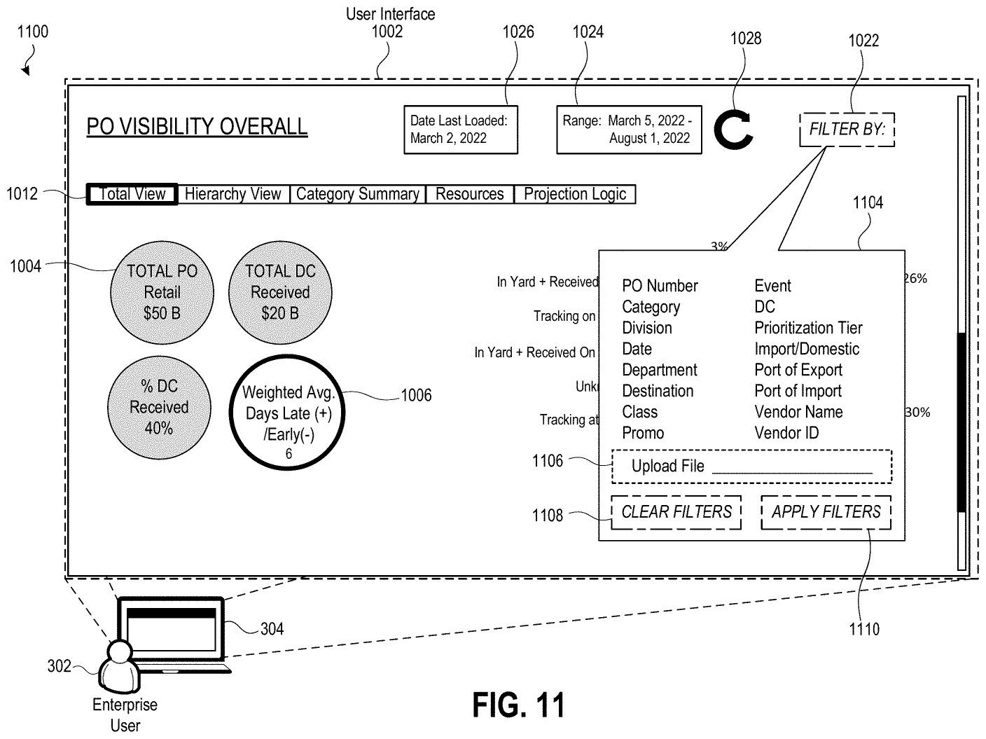

In some examples, user interface 1002 may include interactive displays which may allow the user 302 to make a selection and which may inform the user 302 of the selection. For example, tabs 1012 may correspond to different views or pages from which user 302 may choose. The selected page may be outlined, bolded, encircled, colored differently, or may otherwise indicate which page is selected and displayed (in the particular example shown, “Total View”). User interface 1002 may also include an option to select a date range over which to display data/information, which may be accomplished, in some examples, by interacting with a date range display 1024 (which may then display the selected date range). User interface 1002 may also include an interactive option 1028 to refresh the data on the page, which may pull in the most up-to-date dynamic data (either actual data or predicted, calculated data or a combination, as described above). User interface 1002 may include a display 1026 which displays the date when the data was last loaded. User interface 1002 may also include an option 1022 to filter the displayed data, which will be described further in FIG. 11.

FIG. 11 illustrates the example user interface of FIG. 10, including customizable user options. User interface 1002 may include an option 1022 to filter the displayed data. User 302 may interact with option 1022 (which may be, for example, a button or a link). In some examples, interaction with option 1022 may direct the user 302 to a separate page where they may select filtered options. In the particular example shown, interaction with option 1022 brings up a pop-up 1104 which lists different categories or types of filters that may be applied to the data. The user 302 may select one or more filters to apply. Example categories may include, but are not limited to, purchase order numbers, category, event, promotion, date, destination, prioritization tier, and others. The user 302 may interact with the different filters, which may direct the user to another pop-up or page to select or enter further information (for example, to select a purchase order number from a list, or to enter a purchase order number into a dialog box). Pop-up 1104 may include an area where a user 302 may upload a file 1106. Pop-up 1104 may include a button whereby the user 302 may clear any selected or applied filters. Pup-up 1104 may include a button whereby the user 302 may apply any selected filters to the data. User interface 1002 will then reflect any filters applied or cleared by the interaction of user 302 with pup-up 104.

The ability to filter the displayed data may provide user 302 with the advantage of being able to view dynamic status data and predictions for a specific purchase order or group of items (or individual item) of interest, which may then allow the user 302 to make strategic business decisions based on that data. For example, if the user 302 views data for an important shipment given a prioritization of tier 1, and notices that the shipment is tracking at risk for arriving late, the user 302 may make a business decision (such as expediting later shipping legs or ordering the items from another, closer vendor so that they arrive on time) to mitigate the risk of lost revenue to the business.

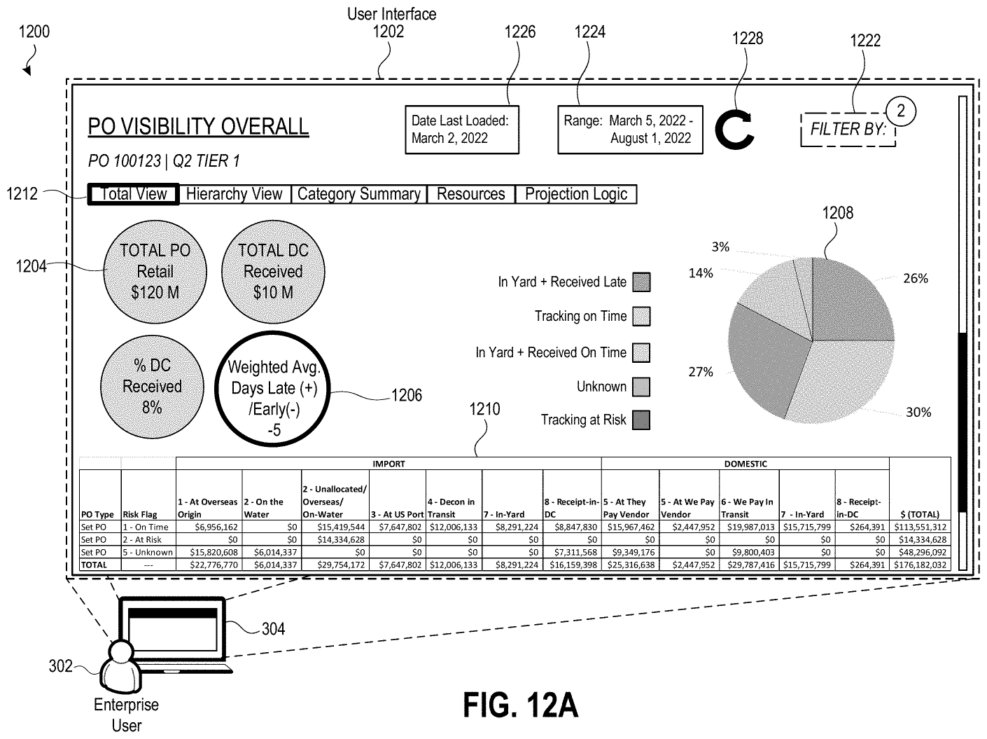

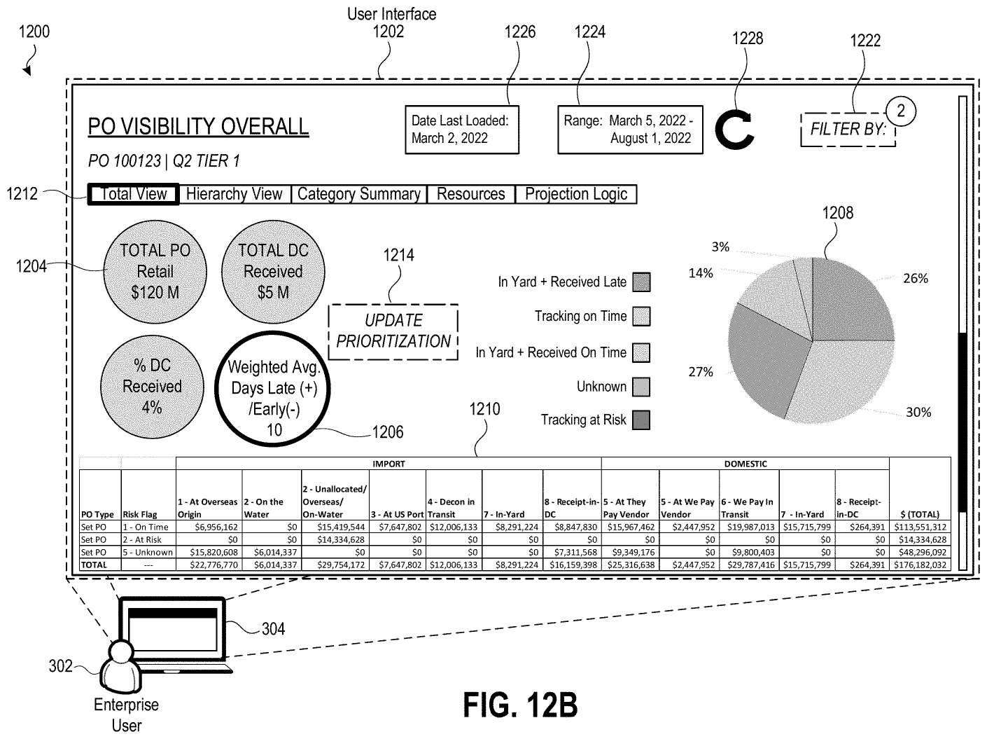

FIG. 12A illustrates an example user interface including a user-customized dynamic purchase order visibility dashboard. In some examples, a display of device 304 may display a user interface 1202 (for example, such as vendor user interface 306). The device 304 may be accessible to an enterprise user 302. User 302 may view information displayed on user interface 1202 and may interact with user interface 1202 utilizing a keyboard, mouse touchpad, touchscreen, remote, voice command, or other interactive methods. In some examples, the user interface 1202 and the data that it displays may be generated as described in the methods described above. The user interface 1202 may be generated, in some examples, by accessing dynamically updated data from one or more databases (for example, purchase order visualization database 312, enterprise databases 310, and/or purchase order database 212).

In some examples, user interface 1202 may present data relating to one or more purchase orders and the shipments of items associated with the purchase orders. In the particular example shown, user interface 1202 includes a total purchase order visibility page, which displays information relating to a particular purchase order and a particular quarter and tier (in the particular example, Q2 and Tier 1; the tier may have been assigned to the purchase order and its items according to the methods outlined in FIG. 4 above) for a specified date range. User interface 1202 includes various summaries 1204 (including a total value of the retail purchase orders, a total value of the items received, and a percentage received), and a weighted average of a number of days late or early for the items received 1206. The summaries 1204 and/or weighted average 1206 may be displayed in different colors based on predetermined performance factors. For example, if the weighted average shows that the items have been over a threshold number of days late, weighted average 1206 may be colored red, but if the items have been over a threshold number of days early, weighted average 1206 may be colored green.

User interface 1202 may also include a graph or chart 1208, depicting status data associated with shipments of items. This status data may include percentages of shipments or items (or values of shipments or items) which are at different stages of the shipment process (for example, in yard (received) and received on time, tracking on time, in yard and received late, tracking at risk (of being received late), and unknown). This status data (as well as data presented elsewhere on user interface 1202) may be actual status data received and consolidated as described above (for example, as outlined in FIG. 5), or it may be predicted data (for example, as outlined in FIG. 5) associated with the purchase order, or a combination of both actual and predicted data.

User interface 1202 may also include a table 1210 depicting additional status data associated with shipments of items of the purchase order. The data may be broken into risk categories, such as on time, at risk, or unknown, in some examples (for example, the risk may be calculated as outlined in FIG. 5). In some examples, the table may include value (for example, dollar amounts) corresponding to different status categories for import and/or domestic shipments of items. In some examples, table 1210 may be depicted on its own page or may be depicted as shown in conjunction with summaries 1204, weighted average 1206, and/or chart 1208.

In some examples, information presented to the user 302 via the user interface 1202 may be in the form of text, diagrams, charts, graphs, tables, checklists, radio buttons, lists, or other indicators.

In some examples, user interface 1202 may include interactive displays which may allow the user 302 to make a selection and which may inform the user 302 of the selection. For example, tabs 1212 may correspond to different views or pages from which user 302 may choose. The selected page may be outlined, bolded, encircled, colored differently, or may otherwise indicate which page is selected and displayed (in the particular example shown, “Total View”). User interface 1202 may also include an option to select a date range over which to display data/information, which may be accomplished, in some examples, by interacting with a date range display 1224 (which may then display the selected date range). User interface 1202 may also include an interactive option 1228 to refresh the data on the page, which may pull in the most up-to-date dynamic data (either actual data or predicted, calculated data or a combination, as described above). User interface 1202 may include a display 1226 which displays the date when the data was last loaded. User interface 1202 may also include an option 1222 to filter the displayed data, which may have similar features to those described in FIG. 11. Filtering option 1222 may also indicate if and how many filters have been applied to the data. In the particular example shown, two filters are depicted as being applied.

FIG. 12B illustrates the example user interface of FIG. 12A, including an option for updating a prioritization of a shipment of items. In some examples, user interface 1200 may automatically display a button 1214 or other interactive option that allows a user 302 to update or change the prioritization assigned to an item, shipment of items, and/or all items associated with a particular purchase order. This button 1214 may be displayed, for example, where a shipment of items is a signed to a particular prioritization. If it is determined that the shipment of items is at a high risk of not being delivered to its destination on time (for example, is estimated to be over a threshold number of days late, or is assigned to a particular risk tier), then this button 1214 may be displayed. The user 302 may then interact with button 1214, which may direct the user 302 to an interface where they may update the prioritization of the shipment of items. For example, the user may choose to increase the prioritization to a higher priority. This may cause, in a particular example, a shipment of items which has not yet been shipped by the vendor to be subjected to expedited shipping once it is shipped so that it may arrive at its destination on time. In some examples, the interface resulting from interaction with button 1214 is a pop-up. In other examples, interaction with button 1214 may direct the user 302 to a separate page where the prioritization may be updated. As described above (see FIG. 7B), a change in the prioritization of an item or shipment of items may cause a new carrier booking to be generated. The updated prioritization as well as updated shipping data may be reflected on the user interface 1200.

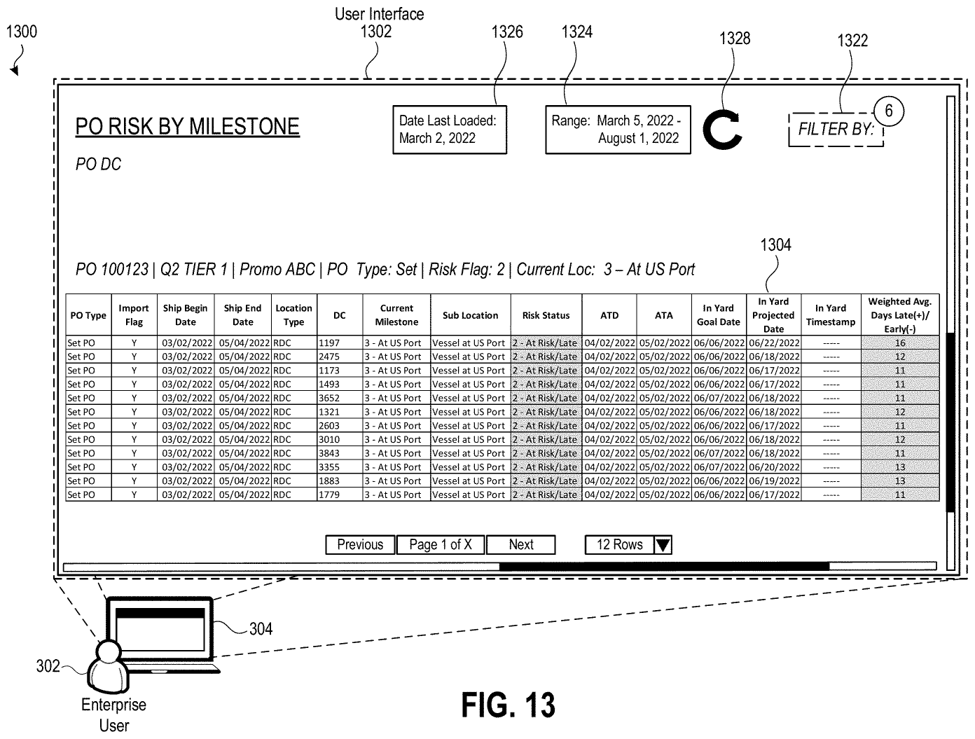

FIG. 13 illustrates an example user interface including calculated risk status on a per-distribution center basis. In some examples, a display of device 304 may display a user interface 1302 (for example, such as vendor user interface 306). The device 304 may be accessible to an enterprise user 302. User 302 may view information displayed on user interface 1302 and may interact with user interface 1302 utilizing a keyboard, mouse touchpad, touchscreen, remote, voice command, or other interactive methods. In some examples, the user interface 1302 and the data that it displays may be generated as described in the methods described above. The user interface 1302 may be generated, in some examples, by accessing dynamically updated data from one or more databases (for example, purchase order visualization database 312, enterprise databases 310, and/or purchase order database 212).

In some examples, user interface 1302 may present data relating to one or more purchase orders and the shipments of items associated with the purchase orders. In the particular example shown, user interface 1302 displays information relating to a specific purchase order and specific distribution center to which several filters have been applied, for a specified date range. In the particular example, the data has been filtered for a particular purchase order, quarter and prioritization tier, promotion, purchase order type, risk flag, and status category.

User interface 1302 may include a table 1304 depicting data and calculated projected data associated with shipments of items. The data included in table 1304 (as well as any data presented elsewhere on user interface 1302) may be actual status data received and consolidated as described above (for example, as outlined in FIG. 5), or it may be predicted data (for example, as outlined in FIG. 5), or a combination of both actual and predicted data. In some examples, the table may include status information and dates, as well as risk and weighted average days late or early, and other relevant data. The columns, rows, cells, and/or text of table 1304 may be displayed in different colors based on predetermined performance factors. For example, if the weighted average shows that the items have been over a threshold number of days late, any such cells of the weighted average column of table 1304 may be colored red, but if the items have been over a threshold number of days early, any such cells of the weighted average column 1304 may be colored green.

In some examples, information presented to the user 302 via the user interface 1302 may be in the form of text, diagrams, charts, graphs, tables, checklists, radio buttons, lists, or other indicators.

In some examples, user interface 1302 may include interactive displays which may allow the user 302 to make a selection and which may inform the user 302 of the selection. User interface 1302 may also include an option to select a date range over which to display data/information, which may be accomplished, in some examples, by interacting with a date range display 1324 (which may then display the selected date range). User interface 1302 may also include an interactive option 1328 to refresh the data on the page, which may pull in the most up-to-date dynamic data (either actual data or predicted, calculated data or a combination, as described above). User interface 1302 may include a display 1326 which displays the date when the data was last loaded. User interface 1302 may also include an option 1322 to filter the displayed data, which may have similar features to those described in FIG. 11. Filtering option 1322 may also indicate if and how many filters have been applied to the data. In the particular example shown, six filters are depicted as being applied.

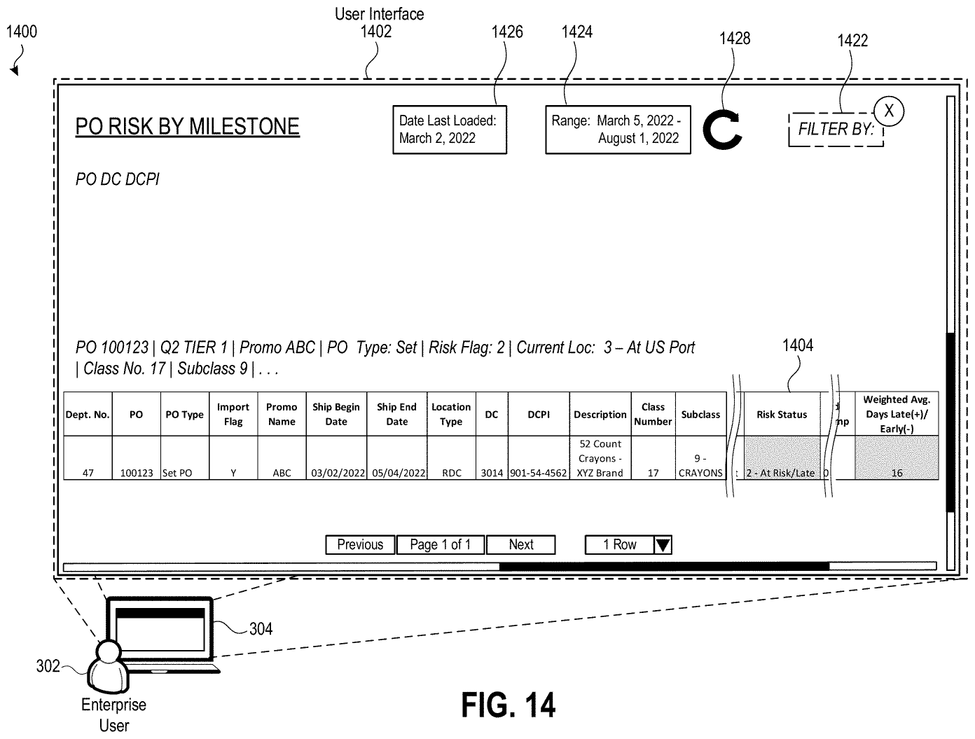

FIG. 14 illustrates an example user interface including calculated risk status on a per-item basis. In some examples, a display of device 304 may display a user interface 1402 (for example, such as vendor user interface 306). The device 304 may be accessible to an enterprise user 302. User 302 may view information displayed on user interface 1402 and may interact with user interface 1402 utilizing a keyboard, mouse touchpad, touchscreen, remote, voice command, or other interactive methods. In some examples, the user interface 1302 and the data that it displays may be generated as described in the methods described above. The user interface 1402 may be generated, in some examples, by accessing dynamically updated data from one or more databases (for example, purchase order visualization database 312, enterprise databases 310, and/or purchase order database 212).

In some examples, user interface 1402 may present data relating to one or more purchase orders and the shipments of items associated with the purchase orders. In the particular example shown, user interface 1402 displays information relating to a specific purchase order, specific distribution center, and specific item (or shipment of items, in some examples) to which several filters have been applied, for a specified date range.

User interface 1402 may include a table 1404 depicting data and calculated projected data associated with the item(s). The data included in table 1404 (as well as any data presented elsewhere on user interface 1402) may be actual status data received and consolidated as described above (for example, as outlined in FIG. 5), or it may be predicted data (for example, as outlined in FIG. 5), or a combination of both actual and predicted data. In some examples, the table may include status information and dates, as well as risk and weighted average days late or early, a description of the item, and other relevant data. The columns, rows, cells, and/or text of table 1404 may be displayed in different colors based on predetermined performance factors. For example, if the weighted average shows that the items have been over a threshold number of days late, any such cells of the weighted average column of table 1404 may be colored red, but if the items have been over a threshold number of days early, any such cells of the weighted average column 1404 may be colored green.

In some examples, information presented to the user 302 via the user interface 1302 may be in the form of text, diagrams, charts, graphs, tables, checklists, radio buttons, lists, or other indicators.

The ability to view dynamic data at a granular, per-item level (for example, where the item is a high-priority item as determined by the methods of FIG. 4) may make it possible for user 302 to make decisions relating to the enterprise and which may minimize or prevent loss of revenue.

In some examples, user interface 1402 may include interactive displays which may allow the user 302 to make a selection and which may inform the user 302 of the selection. User interface 1402 may also include an option to select a date range over which to display data/information, which may be accomplished, in some examples, by interacting with a date range display 1424 (which may then display the selected date range). User interface 1402 may also include an interactive option 1428 to refresh the data on the page, which may pull in the most up-to-date dynamic data (either actual data or predicted, calculated data or a combination, as described above). User interface 1402 may include a display 1426 which displays the date when the data was last loaded. User interface 1402 may also include an option 1422 to filter the displayed data, which may have similar features to those described in FIG. 11. Filtering option 1422 may also indicate if and how many filters have been applied to the data.

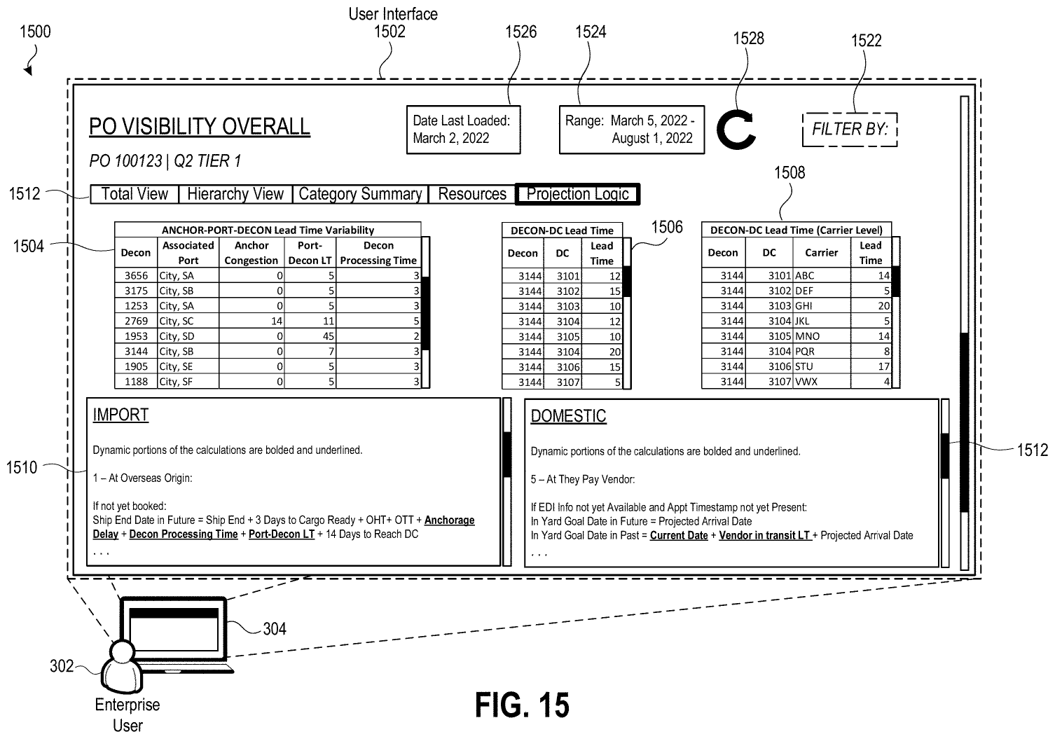

FIG. 15 illustrates an example user interface including example logic and calculation data. In some examples, a display of device 304 may display a user interface 1502 (for example, such as vendor user interface 306). The device 304 may be accessible to an enterprise user 302. User 302 may view information displayed on user interface 1502 and may interact with user interface 1502 utilizing a keyboard, mouse touchpad, touchscreen, remote, voice command, or other interactive methods. In some examples, the user interface 1502 and the data that it displays may be generated as described in the methods described above. The user interface 1502 may be generated, in some examples, by accessing dynamically updated data from one or more databases (for example, purchase order visualization database 312, enterprise databases 310, and/or purchase order database 212).

In some examples, user interface 1502 may display to the user information, constant values, dynamic values, logic, and mathematical relationships and formulas that are at least partially involved in calculating the status milestone data for import and domestic shipments (for example, calculations and formulas that may be utilized in the methods discussed regarding FIG. 5).

User interface 1502 may include table 1504, depicting the lead time variability data associated with various deconsolidator facilities. User interface 1502 may include table 1506, depicting tan average lead time of various distribution centers serviced by a particular deconsolidator facility. User interface 1502 may include table 1508, depicting the lead time of various distribution centers serviced by a particular deconsolidator facility when serviced by various carriers (for example, carriers 125). The data included in tables 1504, 1506, 1508 (as well as data presented elsewhere on user interface 1502) may be actual status data received and consolidated as described above (for example, as outlined in FIG. 5), or it may be predicted data, or a combination of both actual and predicted data.

User interface 1502 may also include text boxes 1510, 1512, which depict calculations and formulas utilized to determine the status milestone data for imports and domestic shipments, respectively. The calculations and formulas displayed may be updated periodically be specialized/authorized enterprise personnel. In some examples, enterprise user 302 may only view the information, but not edit it. In some examples, dynamic factors utilized in the calculations are bolded, underlined, highlighted, and/or are otherwise emphasized. In some examples, user 302 may scroll down within text boxes 1510, 1512 (or may otherwise interact with them) to view more calculations than can be initially fit on the screen.

In some examples, information presented to the user 302 via the user interface 1502 may be in the form of text, diagrams, charts, graphs, tables, checklists, radio buttons, lists, or other indicators.

In some examples, user interface 1502 may include interactive displays which may allow the user 302 to make a selection and which may inform the user 302 of the selection. For example, tabs 1512 may correspond to different views or pages from which user 302 may choose. The selected page may be outlined, bolded, encircled, colored differently, or may otherwise indicate which page is selected and displayed (in the particular example shown, “Projection Logic”). User interface 1502 may also include an option to select a date range over which to display data/information, which may be accomplished, in some examples, by interacting with a date range display 1524 (which may then display the selected date range). User interface 1502 may also include an interactive option 1028 to refresh the data on the page, which may pull in the most up-to-date dynamic data (either actual data or predicted, calculated data or a combination, as described above). User interface 1502 may include a display 1526 which displays the date when the data was last loaded. User interface 1502 may also include an option 1522 to filter the displayed data, which may have similar features to those described in FIG. 11. Filtering option 1522 may also indicate if and how many filters have been applied to the data.

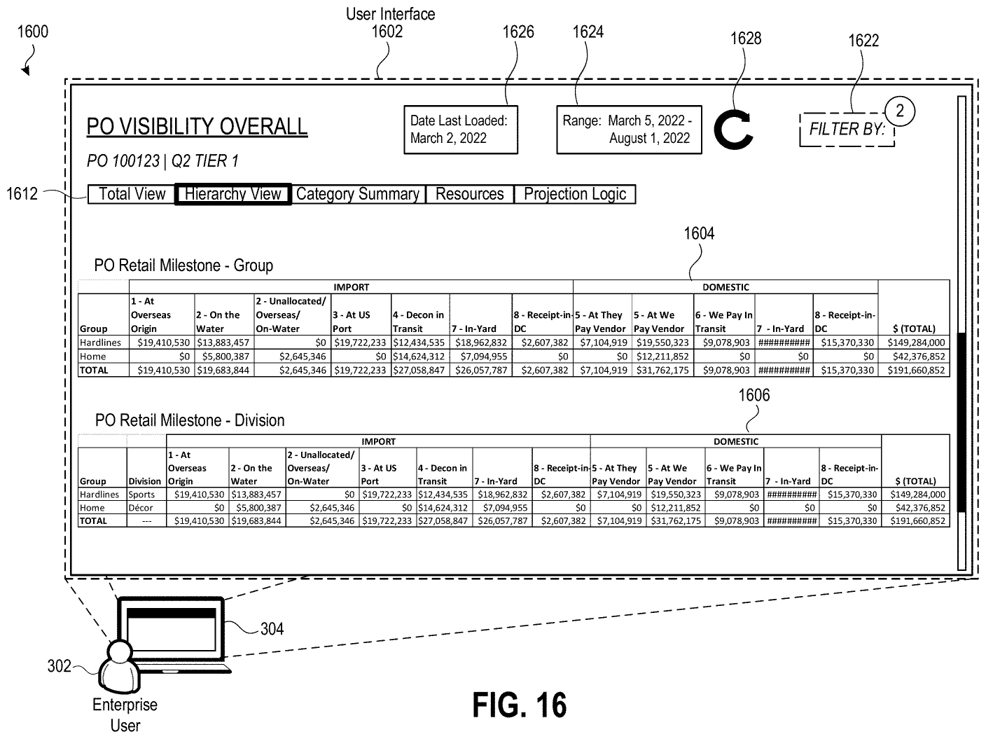

FIG. 16 illustrates an example user interface including import status on a group and division basis. In some examples, a display of device 304 may display a user interface 1602 (for example, such as vendor user interface 306). The device 304 may be accessible to an enterprise user 302. User 302 may view information displayed on user interface 1602 and may interact with user interface 1602 utilizing a keyboard, mouse touchpad, touchscreen, remote, voice command, or other interactive methods. In some examples, the user interface 1302 and the data that it displays may be generated as described in the methods described above. The user interface 1602 may be generated, in some examples, by accessing dynamically updated data from one or more databases (for example, purchase order visualization database 312, enterprise databases 310, and/or purchase order database 212).

In some examples, user interface 1602 may present data relating to one or more purchase orders and the shipments of items associated with the purchase orders. In the particular example shown, user interface 1602 displays information relating to a specific purchase order and prioritization tier, for a specified date range, where the data is shown for different enterprise groups and divisions. Depicting the dynamic data by group and/or division (or other enterprise category or sub-entity) may be beneficial to the users (for example, user 302) within those groups, so they may track and take actions based on the depicted data.

User interface 1602 may include a table 1604 depicting data and calculated projected data associated with the selected purchase order and prioritization tier which has been broken out by group (in this particular example, hardlines and home). User interface 1602 may also include a table 1606 depicting data and calculated projected data associated with the selected purchase order and prioritization tier which has been broken out by division (in this particular example, sports and décor) and additionally indicating group (in this particular example, hardlines and home). The data included in tables 1604, 1606 (as well as any data presented elsewhere on user interface 1602) may be actual status data received and consolidated as described above (for example, as outlined in FIG. 5), or it may be predicted data (for example, as outlined in FIG. 5), or a combination of both actual and predicted data. In some examples, the table may include value (for example, dollar amounts) corresponding to different status categories for import and/or domestic shipments of items.

In some examples, additional or alternative tables may be displayed which correspond to other groups, divisions or other sub-entities, on user interface 1602.

In some examples, information presented to the user 302 via the user interface 1602 may be in the form of text, diagrams, charts, graphs, tables, checklists, radio buttons, lists, or other indicators.

In some examples, user interface 1602 may include interactive displays which may allow the user 302 to make a selection and which may inform the user 302 of the selection. For example, tabs 1612 may correspond to different views or pages from which user 302 may choose. The selected page may be outlined, bolded, encircled, colored differently, or may otherwise indicate which page is selected and displayed (in the particular example shown, “Hierarchy View”). User interface 1602 may also include an option to select a date range over which to display data/information, which may be accomplished, in some examples, by interacting with a date range display 1624 (which may then display the selected date range). User interface 1602 may also include an interactive option 1628 to refresh the data on the page, which may pull in the most up-to-date dynamic data (either actual data or predicted, calculated data or a combination, as described above). User interface 1602 may include a display 1626 which displays the date when the data was last loaded. User interface 1602 may also include an option 1622 to filter the displayed data, which may have similar features to those described in FIG. 11. Filtering option 1622 may also indicate if and how many filters have been applied to the data. In the particular example shown, two filters are depicted as being applied.

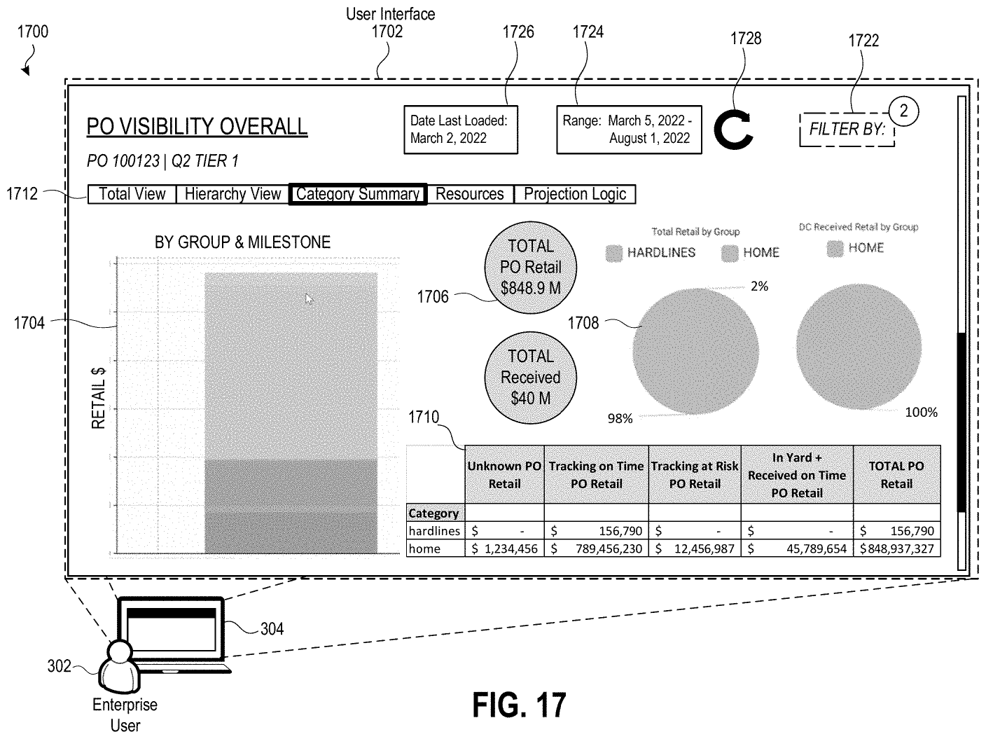

FIG. 17 illustrates an example user interface including a dynamic purchase order visibility dashboard summary for one or more categories. In some examples, a display of device 304 may display a user interface 1702 (for example, such as vendor user interface 306). The device 304 may be accessible to an enterprise user 302. User 302 may view information displayed on user interface 1702 and may interact with user interface 1002 utilizing a keyboard, mouse touchpad, touchscreen, remote, voice command, or other interactive methods. In some examples, the user interface 1702 and the data that it displays may be generated as described in the methods described above. The user interface 1702 may be generated, in some examples, by accessing dynamically updated data from one or more databases (for example, purchase order visualization database 312, enterprise databases 310, and/or purchase order database 212).

In some examples, user interface 1702 may present data relating to one or more purchase orders and the shipments of items associated with the purchase orders. In the particular example shown, user interface 1702 includes a category summary page, which displays information relating to one or more purchase orders (in this particular example, for a particular selected purchase order) for a specified date range. In the particular example shown, user interface 1702 includes graph 1704, which depicts a retail value by group/category and status milestone. User interface 1702 includes various summaries 1006 (including a total value of the retail purchase order, and a total value of the items received). User interface 1702 includes charts 1708 which depict total retail breakdowns by group (for example, what percentage of the items or values of the items of the purchase order is in the hardlines or home group) and retail received at distribution center by group/category.

User interface 1702 may also include a table 1710 depicting additional status data and/or calculated risk category associated with shipments of items, as broken down by group/category.

The status data included in graph 1704, charts 1706, and table 1710 (as well as data presented elsewhere on user interface 1002) may be actual status data received and consolidated as described above (for example, as outlined in FIG. 5), or it may be predicted data (for example, as outlined in FIG. 5), or a combination of both actual and predicted data.

In some examples, information presented to the user 302 via the user interface 1702 may be in the form of text, diagrams, charts, graphs, tables, checklists, radio buttons, lists, or other indicators.

In some examples, user interface 1702 may include interactive displays which may allow the user 302 to make a selection and which may inform the user 302 of the selection. For example, tabs 1712 may correspond to different views or pages from which user 302 may choose. The selected page may be outlined, bolded, encircled, colored differently, or may otherwise indicate which page is selected and displayed (in the particular example shown, “Category Summary”). User interface 1702 may also include an option to select a date range over which to display data/information, which may be accomplished, in some examples, by interacting with a date range display 1724 (which may then display the selected date range). User interface 1702 may also include an interactive option 1028 to refresh the data on the page, which may pull in the most up-to-date dynamic data (either actual data or predicted, calculated data or a combination, as described above). User interface 1702 may include a display 1726 which displays the date when the data was last loaded. User interface 1702 may also include an option 1722 to filter the displayed data, which may have similar features to those described in FIG. 11. Filtering option 1722 may also indicate if and how many filters have been applied to the data. In the particular example shown, two filters are depicted as being applied.

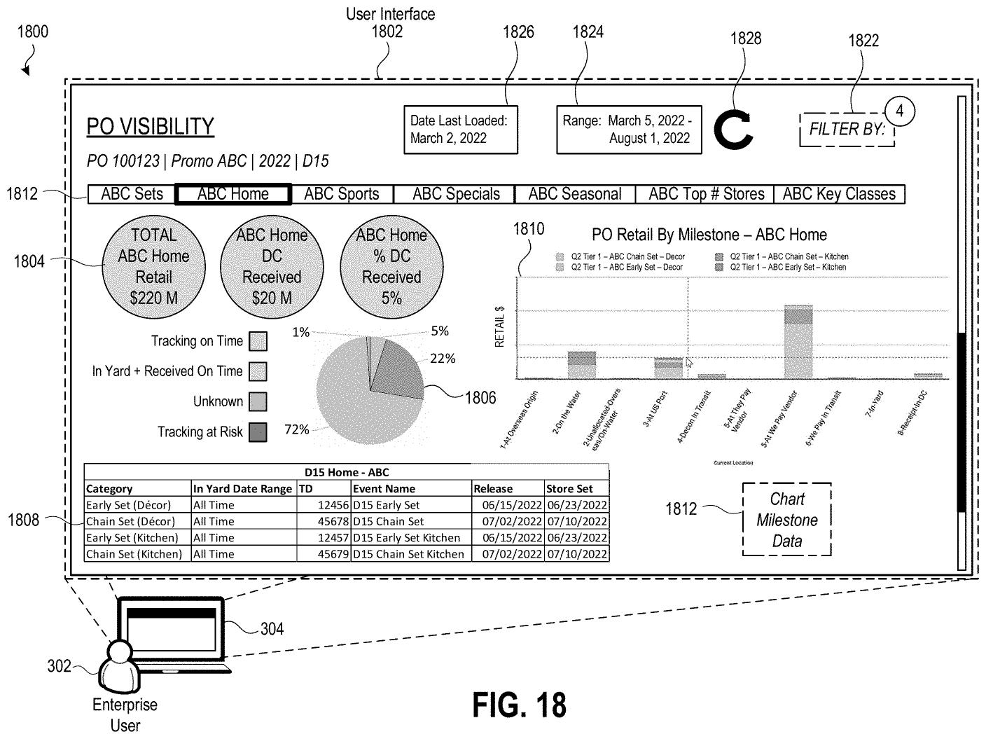

FIG. 18 illustrates an example user interface including data associated with a subset of a specific event. In some examples, a display of device 304 may display a user interface 1802 (for example, such as vendor user interface 306). The device 304 may be accessible to an enterprise user 302. User 302 may view information displayed on user interface 1802 and may interact with user interface 1802 utilizing a keyboard, mouse touchpad, touchscreen, remote, voice command, or other interactive methods. In some examples, the user interface 1802 and the data that it displays may be generated as described in the methods described above. The user interface 1802 may be generated, in some examples, by accessing dynamically updated data from one or more databases (for example, purchase order visualization database 312, enterprise databases 310, and/or purchase order database 212).

In some examples, user interface 1802 may present data relating to one or more purchase orders and the shipments of items associated with the purchase orders. In the particular example shown, user interface 1802 includes displays information relating items of a particular purchase order which correspond to a particular enterprise promotion, for a specified date range. It may be particularly advantageous for user 302 to be able to view dynamic data and predictions related to items related to a particular purchase order and promotion (which may be further narrowed by a location or other factor), where all or some of the items of the purchase order have been given a high priority and/or concerning risk factor (for example, by methods outlined above in the discussion of FIG. 5).

User interface 1802 includes various summaries 1804 (including a total value of the retail purchase orders, a total value of the items received, and a percentage received).

User interface 1802 may also include a graph or chart 1806, depicting status data associated with shipments of items. This status data may include percentages of shipments or items (or values of shipments or items) which are at different stages of the shipment process (for example, in yard (received) and received on time, tracking on time, in yard and received late, tracking at risk (of being received late), and unknown). This status data (as well as data presented elsewhere on user interface 1802) may be actual status data received and consolidated as described above (for example, as outlined in FIG. 5), or it may be predicted data (for example, as outlined in FIG. 5), or a combination of both actual and predicted data.

User interface 1802 may also include a table 1808 depicting data provided by category/group (for example, décor and kitchen) and which may also include information related to retail store events, date ranges, and event dates.

User interface 1802 may also include graph 1810 depicting status data related to the items, including retail value of items (divided by category/group and event) per status milestone and/or current location.

In some examples, information presented to the user 302 via the user interface 1802 may be in the form of text, diagrams, charts, graphs, tables, checklists, radio buttons, lists, or other indicators.

In some examples, user interface 1802 may include interactive displays which may allow the user 302 to make a selection and which may inform the user 302 of the selection. For example, tabs 1812 may correspond to different views or pages from which user 302 may choose. The selected page may be outlined, bolded, encircled, colored differently, or may otherwise indicate which page is selected and displayed (in the particular example shown, where the tabs correspond to specific divisions, “ABC Home”). User interface 1802 may also include an option to select a date range over which to display data/information, which may be accomplished, in some examples, by interacting with a date range display 1824 (which may then display the selected date range). User interface 1802 may also include an interactive option 1828 to refresh the data on the page, which may pull in the most up-to-date dynamic data (either actual data or predicted, calculated data or a combination, as described above). User interface 1802 may include a display 1826 which displays the date when the data was last loaded. User interface 1802 may also include an option 1822 to filter the displayed data, which may have similar features to those described in FIG. 11. Filtering option 1822 may also indicate if and how many filters have been applied to the data. In the particular example shown, four filters are depicted as being applied.

In some examples, user interface 1802 (or any of the previously described user interfaces of FIGS. 9-17) may include buttons or links to more information. For example, user interface 1802 may include button 1812 which may link the user 302 to another page depicting a more detailed chart of status milestone data corresponding to the filtered options.

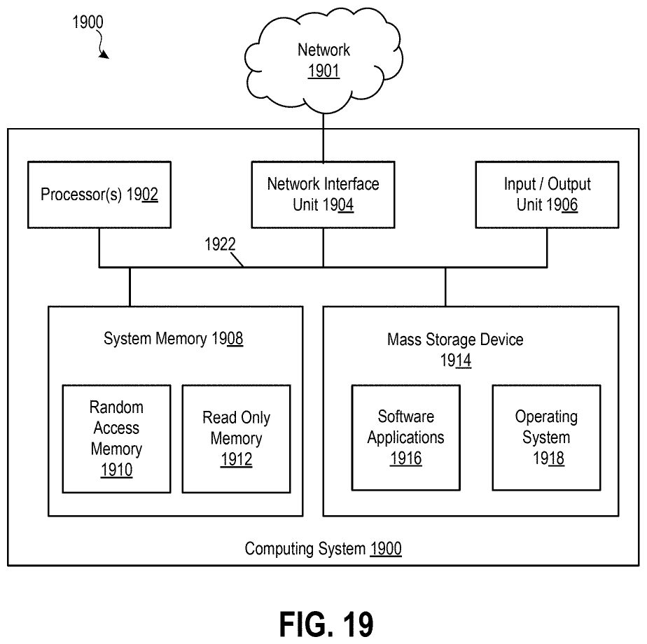

Referring to FIG. 19, an example block diagram of a virtual or physical computing system 1900 is shown. One or more aspects of the computing system 1900 can be used to implement one or more aspects of the present disclosure.

In the embodiment shown, the computing system 1900 includes one or more processors 1902, a system memory 1908, and a system bus 1922 that couples the system memory 1908 to the one or more processors 1902. The system memory 1908 includes RAM (Random Access Memory) 1910 and ROM (Read-Only Memory) 1912. A basic input/output system that contains the basic routines that help to transfer information between elements within the computing system 1900, such as during startup, is stored in the ROM 1912. The computing system 1900 further includes a mass storage device 1914. The mass storage device 1914 is able to store software instructions and data. The one or more processors 1902 can be one or more central processing units or other processors.

The mass storage device 1914 is connected to the one or more processors 1902 through a mass storage controller (not shown) connected to the system bus 1922. The mass storage device 1914 and its associated computer-readable data storage media provide non-volatile, non-transitory storage for the computing system 1900. Although the description of computer-readable data storage media contained herein refers to a mass storage device, such as a hard disk or solid-state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 1900.

According to various embodiments of the invention, the computing system 1900 may operate in a networked environment using logical connections to remote network devices through the network 1901. The network 1901 is a computer network, such as an enterprise intranet and/or the Internet. The network 1901 can include a LAN, a Wide Area Network (WAN), the Internet, wireless transmission mediums, wired transmission mediums, other networks, and combinations thereof. The computing system 1900 may connect to the network 1901 through a network interface unit 1904 connected to the system bus 1922. It should be appreciated that the network interface unit 1904 may also be utilized to connect to other types of networks and remote computing systems. The computing system 1900 also includes an input/output controller 1906 for receiving and processing input from a number of other devices, including a touch user interface display screen, or another type of input device. Similarly, the input/output controller 1906 may provide output to a touch user interface display screen or other type of output device.

As mentioned briefly above, the mass storage device 1914 and the RAM 1910 of the computing system 1900 can store software instructions and data. The software instructions include an operating system 1918 suitable for controlling the operation of the computing system 1900. The mass storage device 1914 and/or the RAM 1910 also store software instructions that, when executed by the one or more processors 1902, cause one or more of the systems, devices, or components described herein to provide functionality described herein. For example, the mass storage device 1914 and/or the RAM 1910 can store software instructions that, when executed by the one or more processors 1902, cause the computing system 1900 to receive and execute managing network access control and build system processes.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of overseas transportation management and status prediction software, technologies disclosed herein are applicable to supply chain software systems generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A method of managing prioritization of overseas imports comprising:
receiving a shipping priority from one or more planning systems within an enterprise, the shipping priority being associated with one or more items to be imported via overseas carriers;
applying a plurality of business rules to a set of pending purchase orders issued to overseas vendors to determine an overall prioritization of the one or more items as included within the set of pending purchase orders;
generating a set of prioritized shipment tiers for the items included within the set of pending purchase orders based on the plurality of business rules;
automatically transmitting prioritized shipment information to an overseas transportation management system, the overseas transportation management system being configured to schedule overseas carriers for shipment of the items to the enterprise; and
scheduling the overseas carriers for transport of the one or more items within the set of pending purchase orders in accordance with the prioritized shipment information.

2. The method of claim 1, further comprising:
receiving, from one or more electronic data interchange transaction tables, dynamic shipment status data associated with the one or more items, wherein at least a portion of the dynamic shipment status data is associated with the overseas carriers;
consolidating the dynamic shipment status data, wherein consolidating the shipment status data comprises:
reconciling the dynamic shipment status data from the one or more electronic data interchange transaction tables;
enriching the dynamic shipment status data with data received at least from: an enterprise vendor shipment coordination tool, one or more enterprise routing systems, an enterprise operations management system, and an enterprise inventory system; and
parsing the consolidated shipment status data per purchase order;
based on the consolidated shipment status data, automatically calculating a dynamic lead time and a dynamic projected arrival date, wherein the dynamic projected arrival date is based at least in part on the dynamic lead time;
automatically calculating a dynamic risk factor, the dynamic risk factor being based on the dynamic projected arrival date and indicating a likelihood that the one or more items will not reach the enterprise by a predetermined goal date; and
generating a dynamic user interface, the user interface displaying at least the dynamic risk factor.

3. The method of claim 2, wherein calculating the dynamic risk factor comprises calculating the dynamic risk factor for all items associated with one purchase order of the set of purchase orders.

4. The method of claim 2, wherein calculating the dynamic risk factor comprises calculating the dynamic risk factor for one item associated with one purchase order of the set of purchase orders.

5. The method of claim 2, further comprising:
determining that the dynamic risk factor indicates that the one or more items will not reach the enterprise by the predetermined goal date;
generating a second set of prioritized shipment tiers for the one or more items based on the plurality of business rules and the determination;
automatically transmitting a second instance of prioritized shipment information to the overseas transportation management system; and
scheduling the overseas carriers for transport of the one or more items within the set of pending purchase orders in accordance with the second instance of prioritized shipment information.

6. The method of claim 2, further comprising:
receiving, from the one or more electronic data interchange transaction tables, second dynamic shipment status data associated with the one or more items;
consolidating the second dynamic shipment status data, wherein consolidating the second shipment status data comprises:
reconciling the second dynamic shipment status data from the one or more electronic data interchange transaction tables;
enriching the second dynamic shipment status data with data received at least from: an enterprise vendor shipment coordination tool, one or more enterprise routing systems, an enterprise operations management system, and an enterprise inventory system; and
parsing the second consolidated shipment status data per purchase order;
based on the second consolidated shipment status data, automatically calculating a second dynamic lead time and a second dynamic projected arrival date, wherein the second dynamic projected arrival date is based at least in part on the second dynamic lead time; and
automatically calculating a second dynamic risk factor, the second dynamic risk factor being based on the second dynamic projected arrival date and indicating a likelihood that the one or more items will not reach the enterprise by the predetermined goal date.

7. The method of claim 2, further comprising the steps of:
determining that the dynamic risk factor indicates that the one or more items will not reach the enterprise by the predetermined goal date;
automatically generating a notification, the notification including at least one of:
the dynamic risk factor,
the dynamic lead time, and
the dynamic projected arrival date; and
transmitting the notification to a user within the enterprise.

8. The method of claim 2, further comprising the steps of:
determining that the dynamic risk factor indicates that the one or more items will not reach the enterprise by the predetermined goal date;
automatically assigning a second set of prioritized shipment tiers for the one or more items, the second set of prioritized shipment tiers indicating a higher priority than the first set of prioritized shipment tiers;
automatically transmitting a second instance of prioritized shipment information to the overseas transportation management system;
selecting one or more second overseas carriers for transport of the one or more items within the set of pending purchase orders, based on the one or more second overseas carriers being associated with a lower second dynamic lead time than the first lower dynamic lead time associated with the first overseas carriers; and
scheduling the one or more second overseas carriers for transport of the one or more items within the set of pending purchase orders.

9. The method of claim 1, wherein receiving the shipping priority comprises receiving shipping priority information from a plurality of different planning systems within the enterprise and reconciling the shipping priority information to provide overall enterprise shipping priority information.

10. The method of claim 1, wherein calculating the dynamic lead time comprises identifying a trend in the consolidated shipment status data, and wherein the dynamic lead time is based at least in part on the identified trend.

11. A system for predicting a dynamic risk factor for a shipment of items, the system comprising:
a software tool executable on an enterprise computing system, the software tool comprising computer-executable instructions which, when executed, cause the enterprise computing system to:
receive, from one or more electronic data interchange transaction tables, dynamic shipment status data associated with the shipment of items, the shipment of items being included within a set of purchase orders, wherein at least a portion of the dynamic shipment status data is associated with one or more overseas carriers;
consolidate the dynamic shipment status data, wherein consolidating the shipment status data comprises:
reconcile the dynamic shipment status data from the one or more electronic data interchange transaction tables;
enrich the dynamic shipment status data with data received at least from: an enterprise vendor shipment coordination tool, one or more enterprise routing systems, an enterprise operations management system, and an enterprise inventory system; and
parse the consolidated shipment status data per purchase order;
based on the consolidated shipment status data, automatically calculate a dynamic lead time and a dynamic projected arrival date, wherein the dynamic projected arrival date is based at least in part on the dynamic lead time;
automatically calculate a dynamic risk factor, the dynamic risk factor being based on the dynamic projected arrival date and indicating a likelihood that the shipment of items will not reach the enterprise by a predetermined goal date; and
generate a dynamic user interface, the user interface displaying at least the dynamic risk factor.

12. The system of claim 11, further comprising instructions causing the enterprise computing system to:
receive a shipping priority from one or more planning systems within an enterprise, the shipping priority being associated with the shipment of items, wherein the shipment of items is to be imported via overseas carriers;
apply a plurality of business rules to the set of pending purchase orders issued to overseas vendors to determine an overall prioritization of the shipment of items as included within the set of pending purchase orders;
generate a set of prioritized shipment tiers for the shipment of items included within the set of pending purchase orders based on the plurality of business rules;
automatically transmit prioritized shipment information to an overseas transportation management system communicatively connected to the enterprise computing system, the overseas transportation management system being configured to schedule one or more overseas carriers for shipment of the items to the enterprise; and
schedule the one or more overseas carriers for transport of the shipment of items within the set of pending purchase orders in accordance with the prioritized shipment information.

13. The system of claim 12, further comprising instructions causing the enterprise computing system to:
determine that the dynamic risk factor indicates that the shipment of items will not reach the enterprise by the predetermined goal date;
generate a second set of prioritized shipment tiers for the shipment of items based on the plurality of business rules and the determination;
automatically transmit a second instance of prioritized shipment information to the overseas transportation management system; and
schedule the overseas carriers for transport of the shipment of items within the set of pending purchase orders in accordance with the second instance of prioritized shipment information.

14. The system of claim 12, further comprising instructions causing the enterprise computing system to:
determining that the dynamic risk factor indicates that the one or more items will not reach the enterprise by the predetermined goal date;
automatically generating a notification, the notification including at least one of:
the dynamic risk factor,
the dynamic lead time, and
the dynamic projected arrival date; and
transmitting the notification to a user within the enterprise.

15. The system of claim 12, further comprising instructions causing the enterprise computing system to:
determining that the dynamic risk factor indicates that the one or more items will not reach the enterprise by the predetermined goal date;
automatically assigning a second set of prioritized shipment tiers for the one or more items, the second set of prioritized shipment tiers indicating a higher priority than the first set of prioritized shipment tiers;
automatically transmitting a second instance of prioritized shipment information to the overseas transportation management system;
selecting one or more second overseas carriers for transport of the one or more items within the set of pending purchase orders, based on the one or more second overseas carriers being associated with a lower second dynamic lead time than the first lower dynamic lead time associated with the first overseas carriers; and
scheduling the one or more second overseas carriers for transport of the one or more items within the set of pending purchase orders.

16. The system of claim 15, wherein the one or more second overseas carriers are different than the first overseas carriers.

17. The method of claim 11, further comprising instructions causing the enterprise computing system to:
receive, from the one or more electronic data interchange transaction tables, second dynamic shipment status data associated with the shipment of items;
consolidate the second dynamic shipment status data, wherein consolidating the second shipment status data comprises:
reconcile the second dynamic shipment status data from the one or more electronic data interchange transaction tables;
enrich the second dynamic shipment status data with data received at least from: an enterprise vendor shipment coordination tool, one or more enterprise routing systems, an enterprise operations management system, and an enterprise inventory system; and
parse the second consolidated shipment status data per purchase order;
based on the second consolidated shipment status data, automatically calculate a second dynamic lead time and a second dynamic projected arrival date, wherein the second dynamic projected arrival date is based at least in part on the second dynamic lead time; and
automatically calculate a second dynamic risk factor, the second dynamic risk factor being based on the second dynamic projected arrival date and indicating a likelihood that the shipment of items will not reach the enterprise by the predetermined goal date.

18. The system of claim 11, further comprising instructions causing the enterprise computing system to:
receive, from an operations management system communicatively connected to the enterprise computing system, the dynamic shipment status data associated with the shipment of items, wherein the operations management system is configured to:
receive raw shipment status data from the one or more overseas carriers on a purchase order basis; and
aggregate the raw shipment status data into the one or more electronic data interchange transaction tables.

19. The system of claim 11, further comprising a user computing device configured to access the enterprise computing system, and wherein the instructions further cause the enterprise computing system to display the dynamic user interface on the user computing device.

20. A computing system including one or more computing devices, the system comprising instructions to execute a first application and a second application, wherein the first application when executed causes the one or more computing devices to:
receive a shipping priority from one or more planning systems within an enterprise, the shipping priority being associated with one or more items to be imported via overseas carriers;
apply a plurality of business rules to a set of pending purchase orders issued to overseas vendors to determine an overall prioritization of the one or more items as included within a set of pending purchase orders;
generate a set of prioritized shipment tiers for the items included within the set of pending purchase orders based on the plurality of business rules;
automatically transmit prioritized shipment information to an overseas transportation management system, the overseas transportation management system being configured to schedule overseas carriers for shipment of the items to the enterprise; and
schedule the overseas carriers for transport of the one or more items within the set of pending purchase orders in accordance with the prioritized shipment information; and
wherein the second application when executed causes the one or more computing devices to:
receive, from one or more electronic data interchange transaction tables, dynamic shipment status data associated with the one or more items, wherein at least a portion of the dynamic shipment status data is associated with the overseas carriers;
consolidate the dynamic shipment status data, wherein consolidating the shipment status data comprises:
reconcile the dynamic shipment status data from the one or more electronic data interchange transaction tables;
enrich the dynamic shipment status data with data received at least from: an enterprise vendor shipment coordination tool, one or more enterprise routing systems, an enterprise operations management system, and an enterprise inventory system; and
parse the consolidated shipment status data per purchase order;
based on the consolidated shipment status data, automatically calculate a dynamic lead time and a dynamic projected arrival date, wherein the dynamic projected arrival date is based at least in part on the dynamic lead time;
automatically calculate a dynamic risk factor, the dynamic risk factor being based on the dynamic projected arrival date and indicating a likelihood that the one or more items will not reach the enterprise by a predetermined goal date; and
generate a dynamic user interface, the user interface displaying at least the dynamic risk factor.
